(19) United States
(12) Patent Application Publication
(10) Pub. No.: US 2002/0035507 A1
(43) Pub. Date: Mar. 21, 2002

(54) Method and system for ordering, customizing, packaging and coordinating the manufacturing and placement of advertisements on packaging

(76) Inventor: Ravneet Singh, Aurora, IL (US)

Correspondence Address: FRANK C. NICHOLAS, CARDINAL LAW GROUP, SUITE 2000, 1603 Orrington Avenue, Evanston, IL, 60201, US

(21) Appl. No.: 09/860,227

(22) Filed: May 18, 2001

Related U.S. Application Data
(63) Continuation-in-part of application No. 09/573,315, filed on May 18, 2000.

(51) Int. Cl. G06F 17/60

(52) U.S. Cl. 705/14

(57) ABSTRACT

A method of reducing packaging costs is provided. The method includes receiving an order for packaging from a customer and applying third party advertising to the packaging. The method can include reducing packaging costs as a percentage of revenue from the third party advertising. The method can include selecting packaging on which to place an advertisement by receiving at least one request to place advertisements on packaging, the request including an advertiser category. At least one request is stored in an advertiser database. An order is received, the order including a customer advertisement preference. The advertisement preference is compared with the advertiser database and each of the at least one requests is selected having an advertiser category matching the customer advertisement preference.

### RELATED APPLICATION

This application claims priority from U.S. application Ser. No. 09/573,315 filed on May 18, 2000, the entire disclosure of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### FIELD OF THE INVENTION

The present invention generally relates to providing packaging solutions. More specifically, the present invention relates to a system for designing, customizing, packaging, ordering, coordinating the manufacturing of and placing advertisements on packaging.

### BACKGROUND OF THE INVENTION

Advertising has grown recently into numerous unconventional or non-traditional markets. Non-traditional advertising has grown at a healthy rate to become a popular medium because companies continue looking for more ways to effectively target their markets, increase brand awareness, and reach out beyond traditional markets to differentiate themselves from competitors. While traditional markets (radio, television, print and newspaper) continue to be a mainstay of advertising, non-traditional media can provide both high impact and value. While being used by Fortune 500 companies, for these reasons, non-traditional advertising media are especially effective when used by small and new companies. Some examples of non-traditional advertising media include bus shelters, product labels, taxicabs, shopping floors, ads on receipts, automobiles, dirigibles, sailboats, the Internet, and direct e-mail. It would be advantageous to provide a new method of advertising that is cost-effective, provides high advertising impact and is simple to implement.

The consumer is continuously bombarded with advertising through traditional mass media. Use of mass media, such as advertising through television, is known as mass advertising. As such it has become increasingly important for advertisers to use a more distinctive, creative and direct methods in order to effectively reach the consumer. This need has given birth to direct advertising. Direct advertising is a non-traditional, cost effective way of communicating a message to a known targeted demographic group. Advertisers are continuously looking for innovative ways to reach the target audience with new and more effective strategies.

Branding has become an integral part of effective marketing in both traditional and non-traditional advertising. The desired target, i.e., the audience that the advertiser wishes to reach, may choose one brand over the other as a function of brand equity. In some cases the brand equity of the company holds more value then the company itself. Common forms of branding are found on packaging or boxes. Package branding can effectively distinguish or separate similar products of separate companies. The branding can be in the form of a company logo, graphics, color, messages and so on. For example, “Gateway”, a company that manufactures and distributes computers, has a unique branding that provides differentiation from other computer manufacturers.

In the event an additional advertisement (from an additional party) is provided on packaging including a first company's brand, for example, the additional advertisement would be referred to as third party advertising. Third party advertisers are advertisers making use of an opportunity to advertise on a medium with or without the branding of the host brand. The advertiser and the brand could be complimentary to each other, i.e., having the same or similar desired target audiences. The third party advertising could be a simple way to expand the advertiser's brand equity and message to a more direct target.

On the other hand, both large and small companies are interested in cost reduction measures as well as the simplification of purchasing and other processes. For example, nearly every company is affected in some way by the cost of shipping containers. By far, corrugated containers or boxes comprise the largest percentage of package containers. Corrugated boxes often include trademarks or other primary indicia related to the enclosed products provided. In this manner, for example, a mail order or Internet company specializing in providing products to catalog or online customers will necessarily purchase large numbers of boxes for use in shipping the products to customers. The cost of shipping boxes to such a company will be significant. The cost of a branded box, including printed trademarks or the like will be greater than a stock brown box. Further, the cost of a customized box, i.e., a box with non-standard configuration or size will be even greater. It would be advantageous to provide a method of defraying the cost of stock, branded and custom boxes.

Manufacturing cost is only one aspect of the cost of boxes. The process of procuring boxes can be an additional factor. Traditionally, retailers order packages directly from a manufacturer. The purchaser and the manufacturer negotiate over such terms as price, size, appearance, color, etc. Artwork can be provided and arranged on the package. After reaching an agreement, the manufacturer creates the packages and ships them to the purchaser. This time-consuming process is inefficient, as the purchaser necessarily is required to contact and negotiate with a number of manufacturers in an effort to obtain the best deal.

One example of such a complex prior art process flow for the ordering of a corrugated container includes a process where a customer or business contacts a manufacturer to place an order for corrugated containers. The manufacturer can be either an integrator or independent. In other words, the manufacturer can be part of a large manufacturing organization with complete design and manufacturing capability or an independent operator that must outsource at least a portion of the manufacturing or design process.

As a result of the order, the manufacturer may need to find a packaging solution to fill the order. The order may include numerous variables such as type of container, size of container, the material of the container and artwork and designs applied to the container. The packaging solution can be processed in-house in the case of an integrator by producing container prototypes and/or a CAD sample. If the manufacturer is an independent, it may be required to outsource production of prototypes or samples.

A cutting die manufacturer will take an order from the integrator or independent manufacturer and produces a cutting die from order specifications of the determined packaging solution.

A printing plate manufacturer will receive CAD or structural specifications from either an in-house design/packaging solutions department or the cutting die manufacturer. The printing plates manufacturer will produce artwork that may include a logo, color, text, a certificate stamp, regulation deadlines and bar codes. The printing plate manufacturer will seek to obtain customer and manufacturer approval of the artwork and may also seek equipment specifications from the manufacturer who is producing the order, whether the manufacturer is a one of the same manufacturer, another independent, or an integrator. Clearly, it would be advantageous to provide a method to simplify the purchasing process.

Another prior art process of manufacturing is illustrated in FIG. 50. The process 700 generally can include customer 710, manufacturer 720, printing plate manufacturer 730 and cutting die manufacturer 740. As indicated, while the process can be variable, in general, a customer 710 places an order 712 with or without a sample to a packaging manufacturer 720. The manufacturer 720 can have a number of packaging solutions 722, which can include stock boxes and custom boxes. The manufacturer 720 can have in-house designers 724 in a consulting role and/or to execute any design contributions. In the alternate, the manufacturer 720 can use an outside design firm 726 in a consulting role and/or to execute any design contributions.

When the customer 710 approves a design, it may be necessary to use a cutting die manufacturer 740 and/or a printing plate manufacturer 730 to provide custom package configuration and/or custom printing to the package. Both the manufacturer 720 from a manufacturing capability and the customer 710 from an aesthetic viewpoint must approve the custom box configuration and the custom printing execution. It can be seen that this complex and time-consuming process can have disadvantages in terms of cost and efficiency.

Therefore, it would be advantageous to formulate a system that, in combination, overcomes the disadvantages described above.

### SUMMARY OF THE INVENTION

Use of third party advertising on boxes can be referred to as “box advertising”. Third party advertising on boxes can reduce the manufacturing cost to a purchaser of the boxes when the third party advertiser shares the cost of manufacturing and can help the advertiser communicate a message to a target through advertising on the box.

The third party advertiser could also have specific messages and promotions targeted at the consumer of the host brand, which could be complimentary to the brand equity of both the third party advertiser and the host.

An aspect of the present invention provides a method of reducing packaging costs with third party advertising including receiving an order for packaging from a customer and applying third party advertising to the packaging.

Other aspects of the present invention provide a method of reducing packaging costs as a percentage of revenue from the third party advertising.

Another aspect of the present invention provides a method for selecting packaging on which to place an advertisement, including receiving at least one request to place advertisements on packaging, the request including an advertiser category. At least one request is stored in an advertiser database. An order is received, the order including a customer advertisement preference. The advertisement preference is compared with the advertiser database and each of the at least one requests is selected having an advertiser category matching the customer advertisement preference.

Another aspect of the present invention provides a method for selecting packaging on which to place an advertisement, including receiving at least one request to place advertisements on packaging, the request including a product category reference. At least one request is stored in an advertiser database. An order is received, the order including a product identification. The product category reference is compared with the product identification and each of the at least one requests is selected having a product category preference matching the product identification.

Another aspect of the invention provides a method of selecting packaging on which to place an advertisement, including receiving customer orders for packaging. At least one advertiser bid or offer is received for the customer order. At least one customer preference is compared with advertiser information, the customer preference corresponding to the customer order and the advertiser information corresponding to the advertiser bid or offer and the advertiser bid is selected matching the customer preference.

Another aspect of the invention provides a method of placing advertising on a package, including receiving an order from a customer, the order including available billboard space on the package. At least one bid is received from at least one advertiser corresponding to the order, the bid specifying the placement of an advertisement on a portion of the billboard space on the package and one of the at least one bids is selected for placement on the package.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A is an exemplary block diagram of an embodiment of a system for ordering, manufacturing and advertising on a package, made in accordance with the present invention;

FIG. 1B is an exemplary block diagram of another embodiment of a system for ordering, manufacturing and advertising on a package, made in accordance with the present invention;

FIG. 2A illustrates a flow chart of an embodiment of a portion of a method of present invention;

FIG. 2B illustrates a flow chart of an embodiment of another portion of the method of the present invention;

FIG. 2C illustrates a flow chart of an embodiment of another portion of the method of the present invention;

FIG. 2D illustrates a flow chart of an embodiment of another portion of the method of the present invention;

FIG. 2E illustrates an embodiment of a commencement page in accordance with the present invention;

FIG. 3 illustrates an embodiment of a product type page in accordance with the present invention;

FIG. 4 illustrates an embodiment of a stock package view page in accordance with the present invention;

FIG. 5 illustrates an embodiment of a custom box list page in accordance with the present invention;

FIG. 6 illustrates an embodiment of a product type listing page in accordance with the present invention;

FIG. 7 illustrates an embodiment of a product customization page in accordance with the present invention;

FIG. 8 illustrates an embodiment of a product design page in accordance with the present invention;

FIG. 9 illustrates an embodiment of a text, advertisement, content message, logo or other content marketing message upload page in accordance with the present invention;

FIG. 10 illustrates an embodiment of a box view page in accordance with the present invention;

FIG. 11 illustrates an embodiment of a box view with logo page in accordance with the present invention;

FIG. 12 illustrates an embodiment of an advertising benefits page in accordance with the present invention;

FIG. 13 illustrates an embodiment of a price calculation page in accordance with the present invention;

FIG. 14 illustrates an embodiment of a border list page in accordance with the present invention;

FIG. 15 illustrates another embodiment of a credit card validation page in accordance with the present invention;

FIG. 16 illustrates an embodiment of a confirmation page in accordance with the present invention;

FIG. 17 illustrates an embodiment of an order-tracking page in accordance with the present invention;

FIG. 18 illustrates an embodiment of a box search input page in accordance with the present invention;

FIG. 19 illustrates an embodiment of a packaging wizard page in accordance with the present invention;

FIG. 20 illustrates an embodiment of a packaging wizard results page in accordance with the present invention;

FIG. 21 illustrates an embodiment of a help page in accordance with the present invention;

FIG. 22 illustrates an embodiment of a tutorial page in accordance with the present invention;

FIG. 23 illustrates an embodiment of flow chart depicting the portion of the method in accordance with the present invention;

FIG. 24 illustrates an embodiment of an advertising home page in accordance with the present invention;

FIG. 25 illustrates an embodiment of an advertising input page in accordance with the present invention;

FIG. 26 illustrates an embodiment of an advertising list page in accordance with the present invention

FIG. 27 illustrates an embodiment of an advertising cost comparison page in accordance with the present invention;

FIG. 28 illustrates an embodiment of an advertising options page in accordance with the present invention;

FIG. 29 illustrates an embodiment of an advertising auction page in accordance with the present invention;

FIG. 30 illustrates an embodiment of an advertising bid page in accordance with the present invention;

FIG. 31 illustrates an embodiment of a confirmation page in accordance with the present invention;

FIG. 32 illustrates a flow chart for one embodiment of another portion of the method in accordance with the present invention;

FIG. 33 illustrates an embodiment of a manufacturer home page in accordance with the present invention;

FIG. 34 illustrates an embodiment of a buyer login page in accordance with the present invention;

FIG. 35 illustrates an embodiment of an order form page in accordance with the present invention;

FIG. 36 illustrates an embodiment of a confirmation page in accordance with the present invention;

FIG. 37 illustrates an embodiment of a manufacturer or seller login page in accordance with the present invention;

FIG. 38 illustrates an embodiment of a bidder login page in accordance with the present invention;

FIG. 39 illustrates an embodiment of a quote placement page in accordance with the present invention;

FIG. 40 illustrates an embodiment of confirmation page in accordance with the present invention;

FIG. 41 illustrates an embodiment of bulletin box page in accordance with the present invention;

FIG. 42 illustrates an embodiment of a registration page in accordance with the present invention;

FIG. 43 illustrates another embodiment of a registration page in accordance with the present invention;

FIG. 44 illustrates another embodiment of a registration page in accordance with the present invention;

FIG. 45 illustrates an embodiment of a spec sheet in accordance with the present invention;

FIG. 46 illustrates an embodiment of a sample e-mail page in accordance with the present invention;

FIG. 47 illustrates an embodiment of an upload and file management page in accordance with the present invention;

FIG. 48 illustrates an embodiment of an Intranet page in accordance with the present invention;

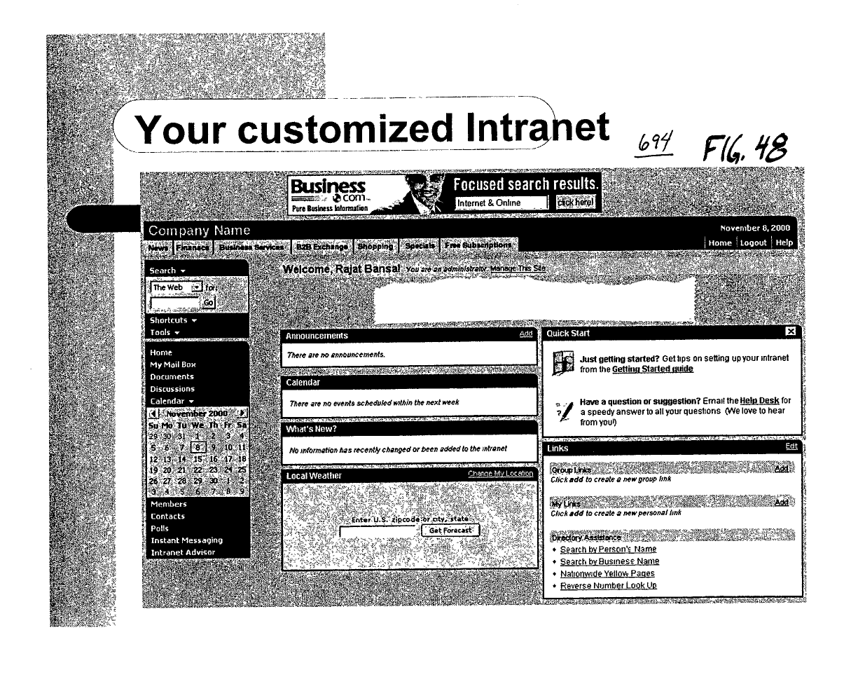

FIG. 49 illustrates an embodiment of an electronic credit system and method; and

FIG. 50 illustrates a prior art embodiment of a box purchasing method.

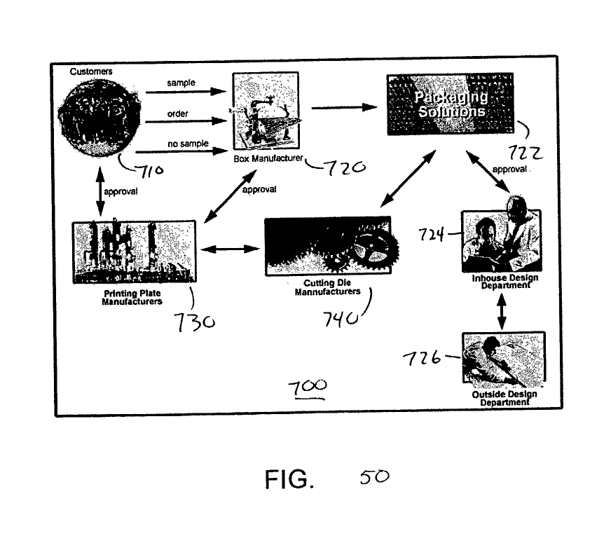

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE PRESENTLY PREFERRED EMBODIMENTS

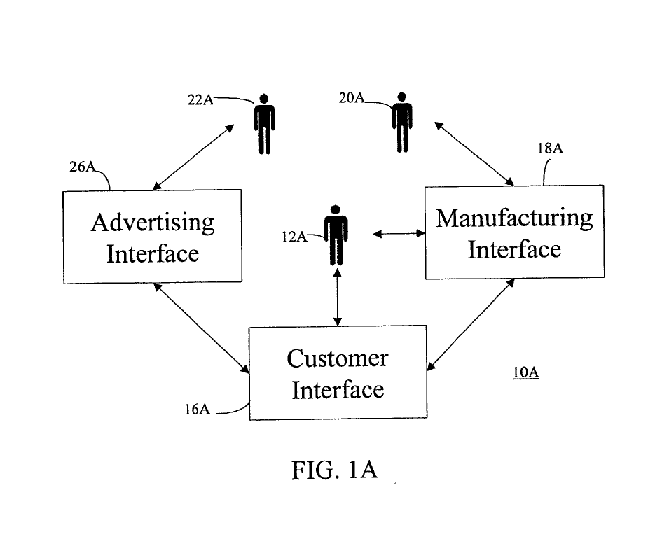

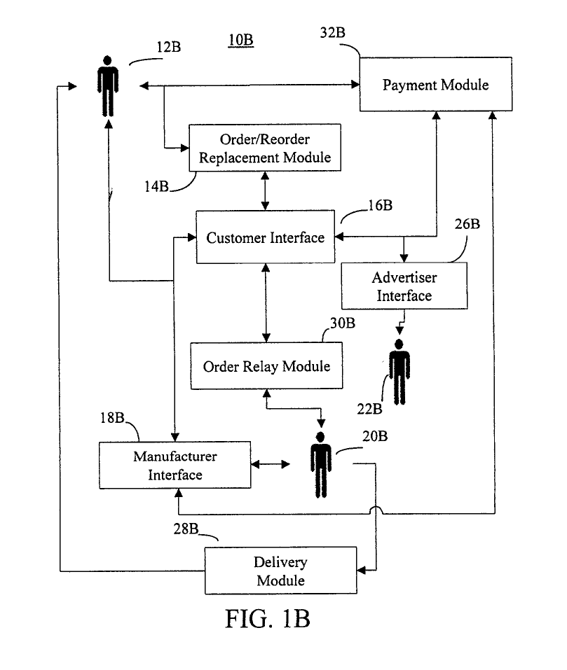

Referring to FIG. 1A, one embodiment of a system for procuring and reducing the cost of packaging with third party advertisements is generally shown at numeral 10A. In the embodiment shown, the system 10A may include a Customer Interface 16A, a Manufacturer Interface 18A, and an Advertiser Interface 26A.

The Customer Interface 16A allows Customer(s) 12A, which may include any entity, to select packaging and/or to customize the selected packaging. The Customer Interface 16A can also offer the customer the option of reducing the cost of the selected packaging by accepting third party advertising on the selected packaging.

The Manufacturer Interface 1 8A allows Manufacturers 20A, which may include any entity, to bid on packaging manufacturing orders requested through the Customer Interface 16A. The Manufacturing Interface 18A may also allow Customers 12A, which may include any entity, to directly request packaging.

The Advertisers Interface 26A allows Advertisers 22A, which may include any entity, such as advertising agencies or businesses looking to place advertisements, to bid or make offers on space on packaging from orders placed through the customer interface or manufacturers interface. The packaging space available for advertising may be referred to as billboard space or box billboard space.

The Interfaces of the system can be entities or functional groups of workers, communication nodes interacting through any network, or the like. The interfaces of the system may communicate with each other with any conventional communication system, including, for example, telephone wireless communication, network communication, including internet and World Wide Web communication, or the like.

In one embodiment, a Customer 12A, which may include any entity, may select packaging with a preference to allow third party advertising on the selected packaging through Customer Interface 16A. The package selection information can be communicated to the Manufacturer Interface 18A and Advertiser Interface 26A. Third party Advertisers 22A, which include advertising agencies, can communicate their interest to advertise on the selected packaging through the Advertiser Interface 26A. Manufacturers 20A can communicate their interest to manufacture the selected packaging through the Manufacturer Interface 18A. A price for the selected packaging, subsidized by revenue from the third party advertiser, can then be offered to the customer through the Customer Interface 16A.

FIG. 1B illustrates one embodiment of a system 10B for customizing, ordering of packaging and coordination of the manufacturing and placing of advertisements on packaging. The system 10B, as will be explained more fully below, can be an unitary or single system, a distributed system or any suitable arrangement of devices, interfaces, modules, nodes or the like. When distributed, various aspects of the system 10B can be capable of file sharing as will be described more fully below. Further, various aspects of the system 10B or method can be shared such as payment, order, messaging, user profiles, pricing and other functions or features.

Packaging or packages includes boxes and other paper, container board, plastic, corrugated sheet or like storage devices. Examples of packages can also include a bag or a container, as well as any material used for wrapping, storing or shipping of products or services. The system 10B can communicate with users by way of the World Wide Web (WWW) or any other interactive means including, but not limited, to telephone lines, Internet and Intranet connections, wireless communication, conventional mail, email, instant messaging, personal and countertop devices and so on. Customers may access Interfaces of the system using conventional methods, such as standard browser software (i.e. Microsoft, Internet Explorer, Netscape) running on a computer with Internet connection.

Referring to FIG. 1B, a user 12B, wishing to purchase a package to be delivered, can place an order with an Order/Reorder Placement Module 14B. It will be understood that the term user as employed herein can refer to a user of the system 10B, and can refer to a Customer, Advertiser or Manufacturer interchangeably depending upon the context. The Order/Reorder Placement Module can be one or more of an aspect of the system 10B, an interface in the system 10B, and an individual or integrated aspect of the system. The order can include, for example, the size and number of packages, the desired delivery date of the packages and the shipping address of the Customer 12B. In one embodiment, the order placed with the Order/Reorder Placement Module 14B includes order preferences of the Customer 12B. Such order preferences may include, for example, the size or dimensions of the desired package, the shape of the desired package, the type of the desired package, the color of the desired package, the number of desired packages, the delivery dates for the desired package, the advertising preferences on the desired packages, etc.

In addition to placing an order with the Order/Reorder Placement Module 14B, the Customer 12B can also send information and details concerning the Customer 12B to the Order/Reorder Placement Module 14B. Such information and details may include, for example, the name of the Customer 12B, the address of the Customer 12B, billing and shipping information, etc.

After receiving the order information and details from the Customer 12B, the Order/Reorder Placement Module 14B can transmit the order information and details to a Customer Interface 16B. In a simple form the Customer Interface 16B can be an aspect of the invention designed for the consumer market to purchase packages. The Central or Customer Interface 16B may comprise an electronic interactive means, such as an Internet site or a telephone, capable of providing an arena in which a Customer 12B may interact with the Customer Interface 16B to request, receive and provide services in connection with the ordering, manufacturing and advertising of packaging. The Customer Interface 16B can further transmit the order information and details to a Manufacturer Interface 18B. Similar to the Customer Interface 16B, the Manufacturer Interface 18B can include an electronic interactive means, such as an Internet site or a telephone, capable of providing an arena in which a Customer 12B and a Manufacturer 20B may interact to provide services in connection with the ordering, manufacturing and advertising of packaging. In a simple form, the Manufacturer Interface 18B can be an aspect of the invention designed for Manufacturers 20B to interact with Consumers 12B. Although the Customer Interface 16B can receive the order information and details from the Order/Reorder Placement Module 14B, and can forward the order information and details to the Manufacturer Interface 18B, the Customer 12B may alternatively be directly connected (to interact directly) with the Manufacturer Interface 18B. In another embodiment, the Module 14B and the Customer Interface 16B can be integrated into a single aspect or interface.

After receiving the order information and details from the Customer Interface 16B, the Manufacturer Interface 18B may, in one embodiment, sort and segregate the order information and details according to a variety of parameters, such as, for example, the geographic location of the Customer 12B, product type, package type, etc. A Customer Zip Code may be used to sort the geographic location of the Customer 12B. The Manufacturer Interface 18B may sort and segregate the order information and details from the Customer 12B on a periodic basis, thereby creating various combinations and groupings based on the parameters. The information and details may be pre-existing, stored or obtainable from sources such as public records, and various databases and SIC code databases and can be used by the system to perform storing or matching operations. Alternatively, the Manufacturer Interface 18B may perform the sorting and segregating in real-time (i.e., as soon as the Manufacturer Interface 18B receives the order information and details).

The Manufacturer Interface 18B may send a request to each packaging Manufacturer 20B meeting a given parameter, such as, for example, geographic location of the Customer. This request can inform each of the Manufacturers 20B as to the specifics of the order information and details. The Manufacturers 20B may submit information to the Manufacturer Interface 18B regarding their capability to manufacture and produce specific and various types of packaging. Information alternatively, may be entered from secondary sources of information, like associations, industry detail databases, etc. Manufacturer capabilities may include, for example, types of equipment, printing/coloring capabilities, and other packaging capabilities. This information can be stored on a database. In some locations, there may be no single Manufacturer 20B capable of providing full service to the Customer 12B. Accordingly, a combination of Manufacturers 20B may be provided to the Customer 12B to provide full service. The database, which may be located integral with or remote from the Customer Interface 16B or the Manufacturer Interface 18, also can include a record of each Manufacturer 20B associated with or contained within the system 10B. The record of each Manufacturer 20B can further include such information as the name, address, telephone number, facsimile number, contact email address and geographic location of the Manufacturer 20B. The geographic location of the Manufacturer 20B may be any reference information capable of geographically distinguishing the Manufacturer 20B, such as for example, the ZIP Code of the Manufacturer 20B.

The geographic location of the Customer 12B, which, like that of the Manufacturer 20B, may include a ZIP Code of the Customer 12B may then be matched with the geographic location of the Manufacturer 20B. The Customer Interface 16B then can send the order information and other details to those Manufacturers 20B located within or economically near (i.e., near enough not to present a substantial overhead for the shipping or correspondence costs) a geographic region corresponding to the geographic region of the Customer 12B. Alternatively, the order information and details may be sent to any Manufacturer(s) 20B in any region depending on necessary requirements of the order, when it is deemed necessary to do so. The order information and details may be sent to the Manufacturers 20B via any variety of electronic or conventional media, such as, for example, telephonic, email or facsimile transmission or normal postal mail. In fact, for purposes of this invention, all transmissions and notifications may be sent via any variety of electronic and conventional media, including, for example, email, facsimile and telephonic transmissions. The transmissions and notifications also can comprise downloadable software that provides an instant messaging service to transmit new orders or accepted bids to the recipient.

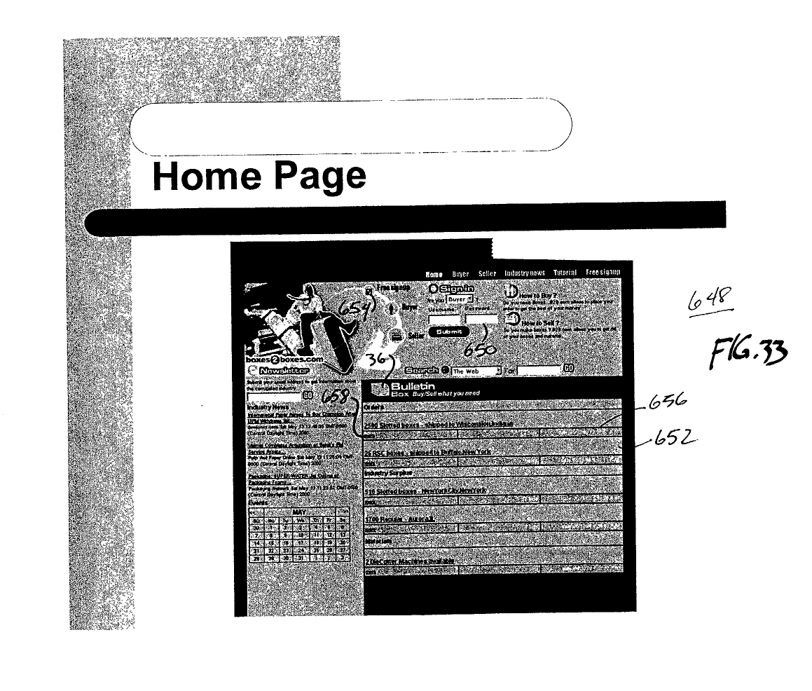

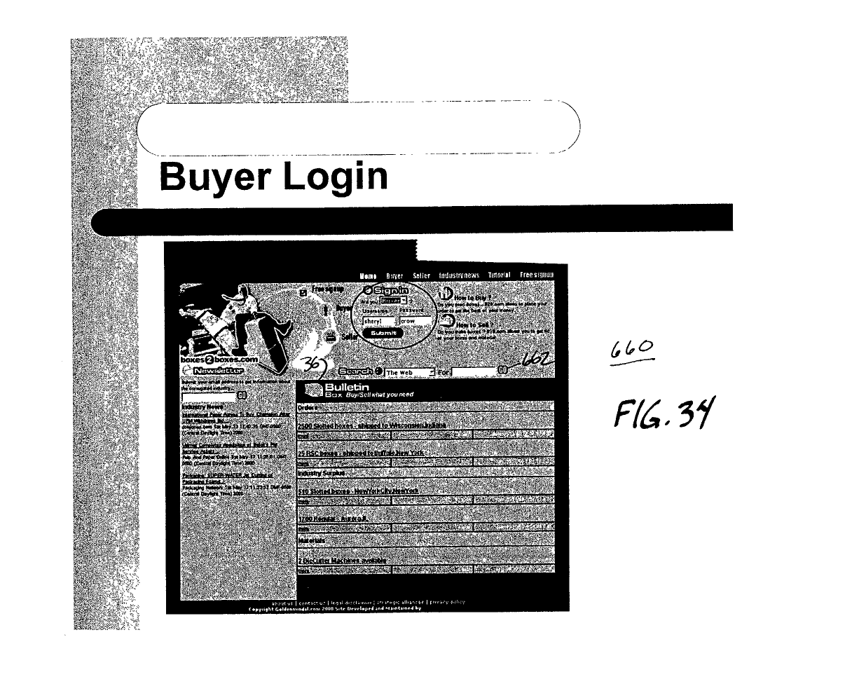

Alternatively, the order information and details may be posted on a Bulletin Board (not shown, see 36 in FIGS. 33 and 34) and, similar to one currently known in the art. The Bulletin Board 36 may be accessible by all registered Manufacturers 20B located within the manufacturer database. The Bulletin Board 36 can be listed privately or publicly, or made available individually to a Manufacturer or Customer and controlled fashion or upon request. The Bulletin Board 36 may include an executable file that runs an application to provide instant notification of the order being placed, received and/or processed. As a result, even those Manufacturers 20B not receiving the order and information details from the Customer Interface 16B (as a result of being outside of the geographic location of the Customer 12B) may submit a bid to manufacture and produce an order of packages.

Upon the receipt of the order information and details, the Manufacturer Interface 18B may respond to the Customer 12B by sending a confirmation email back to the Customer 12B or any suitable communication. The Manufacturer Interface 18B may transmit the confirmation email directly to the Customer 12B. However, the transmission of the confirmation email may follow a reversal of the route taken by the order information and details (i.e., it may be transmitted through the Customer Interface 16B and/or the Order/Reorder Placement Module 14B). The confirmation email, or any suitable communication, may include information helpful to the Customer 12B, such as, for example, an indication that the Customer's 12B order has been received and processed by the system 10B, an indication of any further required information, a notification that a qualifying bid will be selected and delivered to the Customer 12B within a predetermined time period, or any other information that is relevant to the order information and details of the Customer 12B.

Each Manufacturer 20B receiving the request from the Manufacturer Interface 18B may then bid on the Customer's order. Such bids can then be sent back to the Manufacturer Interface 18B through any, a combination of, or all electronic or conventional media. Each bid may include a component for the costs of the manufacture of the packages and the shipment of the packages. The shipment cost may, in some cases, be relatively large, due to, for example, material costs and long-distance delivery costs. After receiving the bids from the Manufacturers 20B choosing to bid, the Manufacturer Interface 18B can then select at least one bid. The bid selection may be based on one or more of the order preferences, submitted by the Customer 12B with some or all of the order information and details. The Manufacturer Interface 18B can control which of the order preferences are used by the Interface to make the selection. A selected bid may be a combination of bids submitted by a plurality of manufacturers each of which are capable of fulfilling components such as (printing, cutting, etc.) in the order submitted by the Customer 12B.

After selecting at least one bid, the Manufacturer Interface 18B may then notify the Customer 12B of the selected bid(s). This allows the Customer 12B to make the choice as to which of the selected bid(s) the Customer 12B wishes to choose for the manufacture and production of the desired packages. Notification to the Customer 12B may be sent via email or facsimile from the Manufacturer Interface 18B, or by sending the selected bid to the Customer Interface 16B, where it may be viewed by the Customer 12B or by any other form of notification, including facsimile, telephone call, etc. Furthermore, notification to the Manufacturer 20B may take place via an Order Relay Module 30B which can be any freestanding or integrated aspect of the system 10B or a portion of Manufacturer or Customer Interface 20B, 16B.

Additionally, the order preferences, sent with the order and information details, may further include an advertisement preference. A positive advertisement preference indicates either an assent to the placement of third party advertisements upon the Customer's 12B packages or an assent to the placement of the Customer's advertisements upon the Customer's 12B packages. Alternatively, the Customer 12B may choose to buy a percentage of available space on the package, ranging between 0 to 100 percent, and to permit third party advertisements on the remaining space. The preferences can include categories of advertisement not desired by the customer, for example, a competitor. The cost advantage that the Customer 12B would receive through advertising may be directly proportional to the amount of package space permitted for third party advertising. Other suitable cost reduction options are contemplated. For example, the cost reduction to the Customer 12B can be based on a spacing, pricing or straight fee model. A negative advertisement preference indicates that the Customer 12B does not wish to include advertisements upon the desired packages.

After receiving the order information and details, the Customer Interface 16B can scan the order preferences for a positive advertisement preference. Upon discovering a positive advertisement preference, the Customer Interface 16B can send the order information and details to the Advertiser Interface 26B. In a simple form, the Advertiser Interface 26B can be an aspect of the invention designed to allow Advertisers 22B to offer or bid for available advertising space. There, the order preferences can be compared to a database of advertiser preferences. The database of advertiser preferences can include at least the name of the Advertisers 22B (which may include Advertising Agencies or any other individual or entity desiring to place an advertisement) along with a preferred category of products and/or any type of entity or individual that wants to place an advertisement. The preferred category of products can then be matched with the category of product information contained within the order details and information. In one environment, the Advertiser Interface 26B can return to the Customer Interface 16B, those advertisements having advertising preferences matching or complementary to the product of the Customer 12B or relationships predetermined by the Interface 26B. Alternatively and additionally, the Advertiser Interface 26B may match the Customer's 12B preference with the Advertiser's 22B product. Similar to the database of Manufacturers 20B, the database of advertiser preferences may be located integral with or remote from the Customer Interface 16B.

Once the match above has been made, the information can be sent to the Customer Interface 16B, where the Customer 12B may choose which advertisements are to be placed on the package. Alternatively, the Customer 12B may waive his right to such a choice. Additionally, a generic, broad list of advertisers for the mass market (e.g., AOL, amazon.com, etc. or advertisers that have an interest in advertising on all types of packages and product categories) may be located on the Customer Interface 16B and presented once the Customer 12B makes a positive advertisement preference. The Customer 12B may then be given the option to approve the advertisements. Accordingly, the Advertisers 22B may be placed in any order for any Customer 12B. Alternatively, the Customer 12B may enter a preferred advertiser portfolio at the Customer Interface 16B or at the Advertiser Interface 26B or at any other relevant aspect of the application, along with other details and preferences of the Customer 12B, which will be used for placing advertisements on the repeat order(s) of the Customer 12B. The Advertiser 22B can be notified to give indirect advertisement or artwork, or the like, to the customer's product associated with the packaging order or the packaging order itself. Moreover, the process of advertisement selection can take place during any of one or more phases of the total order to delivery process (i.e., the advertisement option may be exercised and/or modified by the Customer 12B at the time prior to printing the package and/or printing on the material which is attached or laminated to the package).

The Customer Interface 16B may then reduce the cost of the selected manufacturer's bid by a percentage of the advertisement placement cost. That is, depending upon the size of the advertisement placed upon the Customer's 12B packages, the cost submitted by the Manufacturer 20B may be reduced. For example, if the advertisement is a one square inch advertisement, the cost of the packages may be reduced by one percent. Other suitable cost-reduction methods could be employed. The specific value of the reduction of the cost may vary dependent upon the system 10B in use. As is the case with the selected bid(s), the Customer Interface 16B can then notify the Customer 12B of the reduced bid.

Once the order has been confirmed, the Manufacturer 20B produces the packages, and ships the packages to the Customer 12B. Any information required between the Manufacturer 20B and the Customer 12B can take place via a Delivery Module 28B. The Delivery Module 28B may allow for online conferencing and communication between the Manufacturer 20B and the Customer 12B to further discuss manufacturing, shipping and timing details. The Delivery Module 28B can an integral aspect of the system or can be an aspect of one of the Interfaces 16B, 18B. Furthermore, the payment of the order by the Customer 12B may be sent to the Customer Interface 16B via the Payment Module 32B. In such a case, upon receiving the payment, the Customer Interface 16B forwards the payment to the Manufacturer 20B via either the Manufacturer Interface 18B or the Order Relay Module 30B. The system 10B can be configured in a flexible fashion including the option for the Customer 12B to make payments through the Manufacturer Interface 18B. In a similarly flexible fashion, the Manufacturer 20B may receive payment through the payment module via the Manufacturer Interface 18B. It will be understood that the Delivery Module 28B and the Payment Module 32B can be a part of the system 10B or can be independent entities such as a separate shipping company and an accounting firm, respectively.

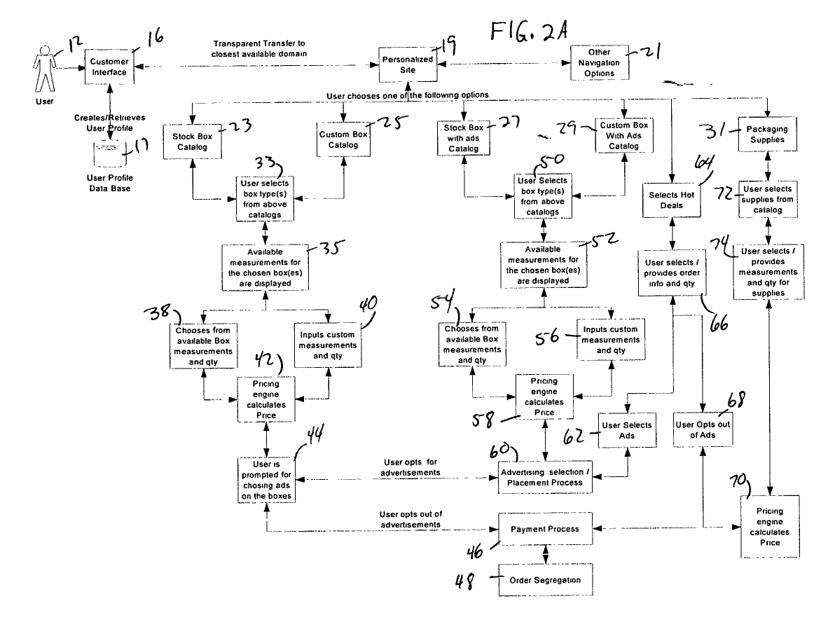

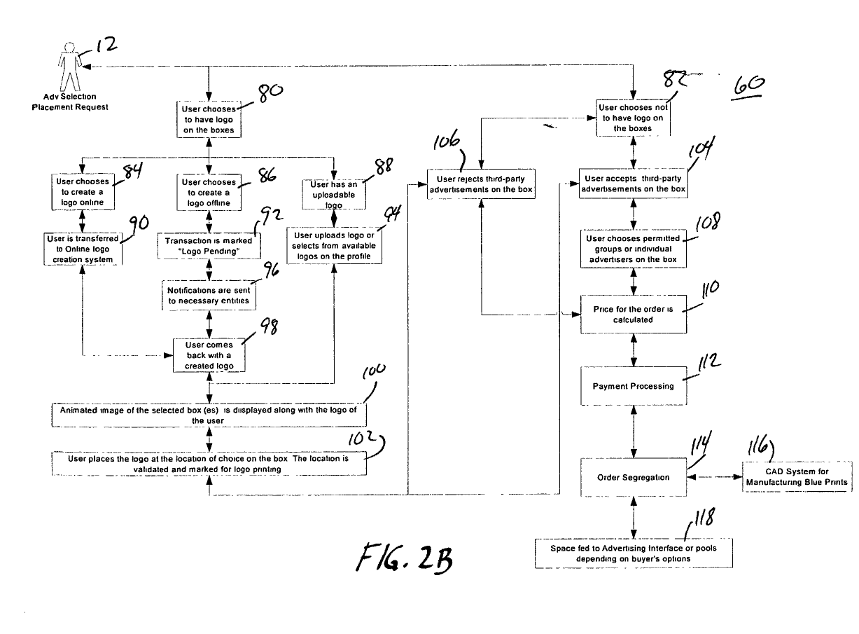

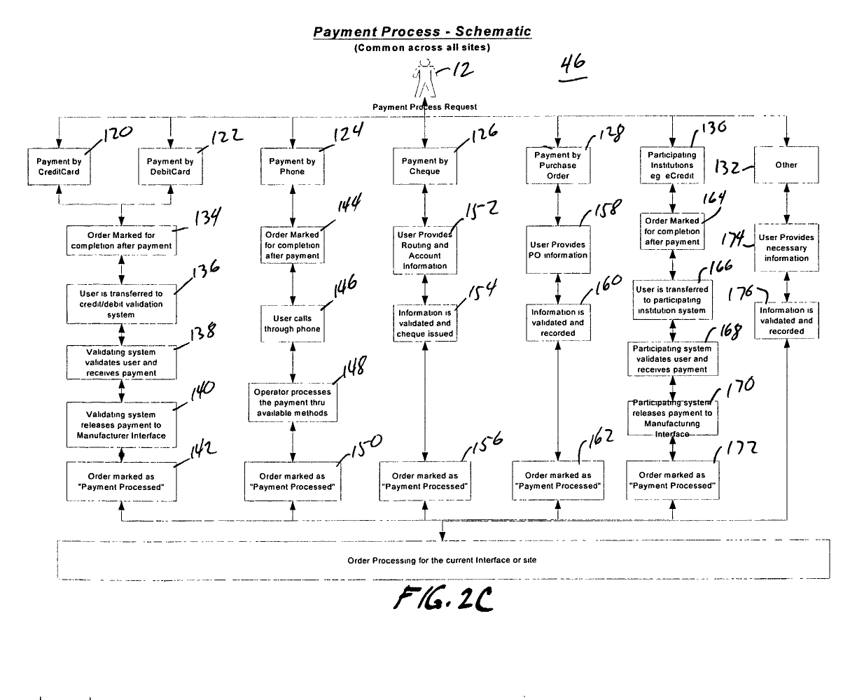

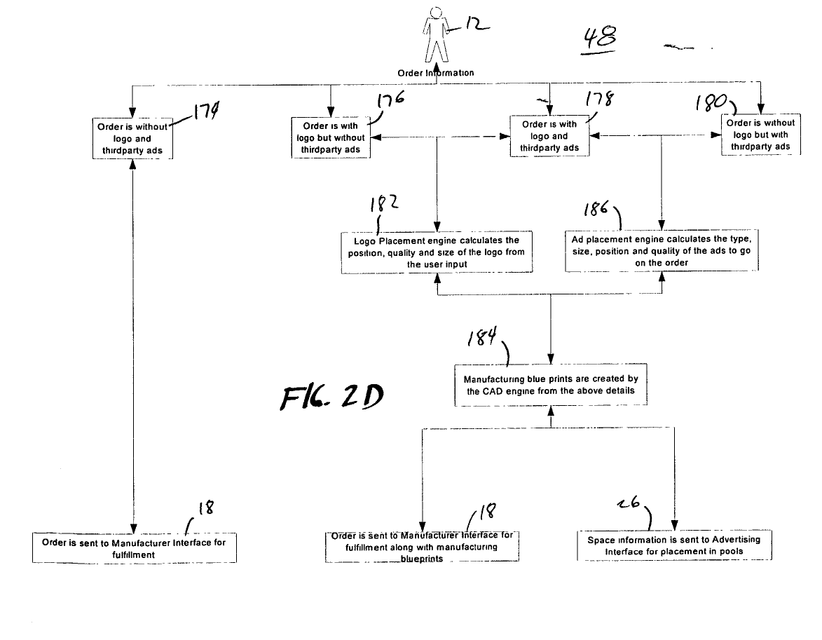

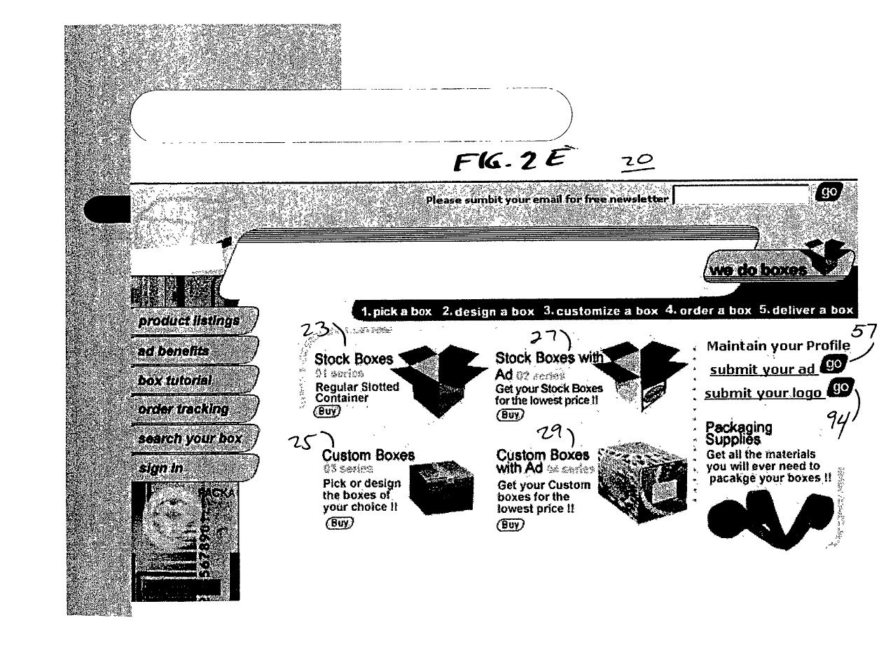

FIG. 2A illustrates an embodiment of a method for placing an order between a user, which can be a Customer 12 and a Customer Interface 16. The first time that a Customer 12 accesses the Interface 16 an opportunity is provided to create a new user profile. In the event that Customer 12 is a repeat customer, a customer profile can be retrieved from a user profile database 17. In the event that the Interface 16 is part of a distributed network or the like, the Customer 12 can be transferred to the closest available domain site. The Customer 12 can access a personalized site or Interface 19. Other navigation or communication options 21 can be provided.

From site 19, the user 12 can choose one or more products or services. The user can access a stock box catalog 23, a custom box catalog 25, a stock box with advertisements catalog 27, a custom box with ads catalog 29 or a packaging supplies catalog 31 or the like. For example, the user 12 can select either the stock box catalog 23 or a custom box catalog 25 the user can select a box type 33 from the above catalogs and can be provided with available measurements for the chosen boxes 35. In the event that the user 12 selects a stock box, the user can be provided a choice from available box measurements and quantity 38. In the event the user 12 selects a custom box, an opportunity to input custom measurements and quantity can be provided to 40. Based on the user 12 selections, a pricing engine calculates the price of the order 42. At this point, user 12 can be prompted for choosing advertisements on the boxes 44. If the user selects an option to not advertise, the customer is referred to payment process 46 in the process continues to an order segregation step 48. If the user 12 selects an option to advertise an advertising selection and placement process can be provided 60. A portion of the advertising selection process can involve the selection of an advertisement 62. A pricing engine can be given the opportunity to calculate the price before proceeding to the payment process 46 and the order segregation process 48.

In the event the user 12 selects from a stock box with advertisements catalog 27 over the custom box with ads catalog 29, the user 12 can be provided an opportunity 50 to select the box types from the above catalogs 27, 29. The available measurements for the chosen boxes can be displayed 52. In the event the user chooses a stock box with ads, an opportunity to choose from available box measurements and quantity can be provided 54. In event the user selects a custom box with ads, the user inputs custom measurements and quantity of the selected boxes 56. From the selection, a pricing engine calculates the price 58, which can be the same pricing engine or a different pricing engine as engine 42. Since the user 12 has preselected boxes with ads, and advertising selection and placement process is presented 60. A portion of the selection process 60 involves selection of advertisement 62.

From the personalized site 19 the user 12 can select special deals 64, which may include access corrugated stock or the like. In this instance, a user 12 can select appropriate stock and provides specific order information and quantity 66. The user may select ads 62 or may select not to include ads 68. As before, regardless of whether the selected boxes include advertising 62 or omits advertising 68 a pricing engine 70 calculates the price of the boxes. The process proceeds to a payment process 46 and then onto an order segregation process 48.

As an option, user 12 can be provided with an option to view a packaging supplies catalog 31. The user can select supplies from the catalog 72. The user 12 can select or provide measurements and quantity criteria for the selected supplies 74. Pricing engine 70 calculates the price of the goods. The process can proceed to a payment process 46 and then onto an order segregation process 48, which will be explained more fully below.

An embodiment of the advertising selection and placement process 60 is depicted in FIG. 2B. Customer 12 can elect to have a logo placed on the boxes 80 or can elect to omits placing artwork, including a logo, slogans, marketing messages, brand promotions, special promotions, or the like on the boxes 82. When electing 80 to have artwork placed on the boxes the user can choose to create artwork online 84, choose to create artwork off line 86 or provide the artwork 88. If user 12 chooses to create artwork online 84, user 12 is transferred to an online creations system 90. If the user chooses to create artwork offline 86, transaction can be marked “logo pending” 92. In this case, notifications are sent to necessary entities 96 and the process can be paused until the user comes back with the created artwork 98. When the user 12 creates a logo, it can be uploaded 94 or the like.

If the user 12 has a loadable logo 88, the user can upload the logo (or other artwork) or can select from an available logo on the profile 94. When the logo is uploaded 94 and selected an animated image of the selected box or boxes can be displayed along with the logo of the user 100. Using an appropriate utility, user 12 can place the logo at the location of choice on the box, which can be validated and marked for logo printing 102. It will be understood that the user 12 can select preloaded or stored artwork, can retrieve pre-stored configurations, can choose to work with newly loaded artwork and so on, as will be explained in more detail below.

Whether the box includes a logo or not, user 12 can elect 104 or reject 106 third party advertisements on the box. If the user 12 chooses to permit groups or individual advertisers on the box, this desire is indicated at 108. Regardless of whether the box includes third party advertisements 108 or rejects third party advertisements 106, a price for the order is calculated 110. The process can then continue to payment processing 112 and an order segregation process 114. Processing step 112 and process 114 can be the same as process 46 and process 48 shown FIG. 2A.

Process 60 can include a CAD system for manufacturing blueprints 116. As a result of the order segregation process space available can be sent to an advertising pool 118 or Advertising Interface 26 depending on customer options.

An embodiment of a payment process 46 is shown in FIG. 2C. Customer 12 can elect to pay via a number of different payment schemes. For example, payment can be made by credit card 120, credit card 122, by phone 124, by check 126, by purchase order 128 or by a variety of participating institutions, e.g., eCredit 130 or other methods 132. If the user 12 elects to pay by credit card or debit card the order is marked for completion after payment 134. The user can be transferred to a credit or debit validation system 136. Validation system 136 can validate the user and receive payment 138. Validation system 136 can release payment 140 directly to the interface providing company. The order can be marked as “payment processed” 142.

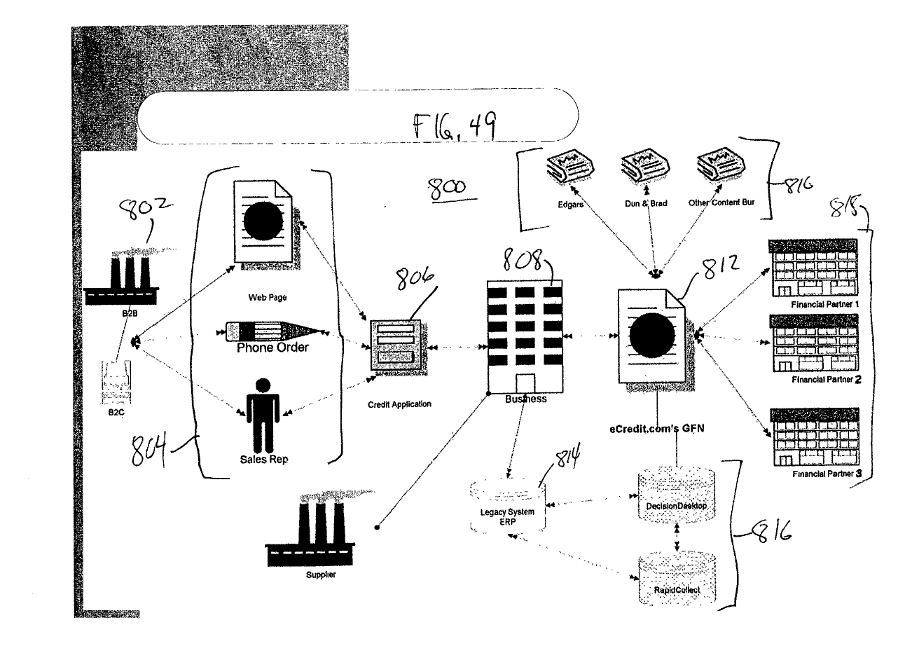

If the user 12 elects to pay by phone 124 the order can be marked for completion after payment 144. User calls the interface company by telephone 146. An operator can process the payment through available methods 148, and the order can be marked as “payment processed” 150. If the user 12 elects to pay by check 126, the user provides routing and account information 152. The information can be validated and a check can be issued 154, and the order can be marked as “payment processed” 156. If the user 12 elects to pay by purchase order 128, the user can provide purchase order information 158. Information can be validated and recorded 160, and the order can be marked as “payment processed” 162. If the user elects to pay using an electronic credit method 130, the order can be marked for completion after payment 164. The user can be transferred to a participating institution 166 (see FIG. 49).

Referring to FIG. 49, an embodiment of an electronic credit system is generally illustrated. Generally a Customer can elect to apply for credit in relation to purchase of packaging through the system at 802. Application for credit can take place through one or more channels of communication system 804, which can be any suitable means of exchanging appropriate information from the system 802 to a credit application site or node 806. The customer business 808 which may have associated records through, for example a legacy system ERP 814 can through application 806 apply for financial credit at electronic site 812. Site 812 can access historical and/oror current financial records through conventional suppliers 810, for example Dun & Bradstreet. The site 812 through decision and collection aspects can access the system 814 and in the event the credit application is approved, can poll financial partners 818 to obtain a suitable financing.

Returning to FIG. 2C, the participating system can validate the user and receives payment 168. The participating system can release payment to the interface company 170, and the order can be marked as “payment processed” 172. Similarly, if the user 12 elects to use another system 132, the user can provide necessary information 174, and information can be validated and recorded 176. Additional data are information related to the user profile can be process to aid in the payment process and/or delivery process, and/or fulfillment process.

One embodiment of an order segregation process 48 is illustrated in FIG. 2D. Order information from the user 12 can be segregated according to the following criteria. One type of order 174 includes no logo or third party advertisement. A second type of order 176 includes a logo but does not include third party advertisement. The third type of order 178 includes both logo and third party advertisement. The fourth type of order 180 includes no logo but does include third party advertisement.

If the order does not include a logo or third party advertisement 174 the order sent directly to the Manufacturer Interface 18 for fulfillment. If the order includes a logo but does not include third party advertisement 176 a logo placement engine can calculate position, quality and size of the logo from the user input 182. The CAD engine from the above details 184 can create manufacturing blueprints. Then the order can be sent directly to the Manufacturer Interface 18 for fulfillment. If the order includes a logo and third party advertisement 178, the logo placement engine can calculate position, quality and size of the logo from the user input 182 and an advertisement placement engine calculates the type, size, position and quality of the advertisement to go on the order 186. A CAD engine from the above details 184 creates manufacturing blueprints. The order can be sent to the Manufacturing Interface 18 for fulfillment along with manufacturing blueprints. At the same time, space information can be sent to the Advertising Interface 26 for placement in pools.

If the order does not include a logo but does include third party advertisement 180 an advertisement placement engine can calculate the type, size, position and quality of the advertisement to go on the order 186. The CAD engine from the above details 184 can create manufacturing blueprints. Then the order sent to the Manufacturing Interface 18 for fulfillment along with manufacturing blueprints. At the same time, space information can be sent to the Advertising Interface 26 for placement in pools.

FIGS. 2E and 3-23 illustrate one embodiment of a method for placing an order between the Customer and the Customer Interface 16. The Customer can enter an order site or commencement “page” 20, shown as FIG. 2E. The order commencement “page” 20 may, as is shown in FIG. 2E, comprise a World Wide Web (WWW) page on the Internet, or, alternatively, any other suitable method or system of providing an interaction between the Customer 12 and the Customer Interface 16. Some of the methods contemplated include electronic or conventional media, such as, for example, a computer connection, a telephone communication, a wireless connection, e-mail, instant messaging or a facsimile transmission. Upon entering the order commencement page 20, the Customer 12 can be presented with a selection of various types of packaging. For example, in FIG. 2E, the Customer 12 may select from a stock box without advertising 23, a stock box with advertising 27, a custom box without advertising 25 or a custom box with advertising 29. Additionally, the Customer 12 can be presented with the opportunity to upload artwork, for example, a logo for advertising 94, as well as to submit an advertisement 57. For example, the source code for one embodiment of the functionality of the Customer Interface 16 is attached at Appendix A.

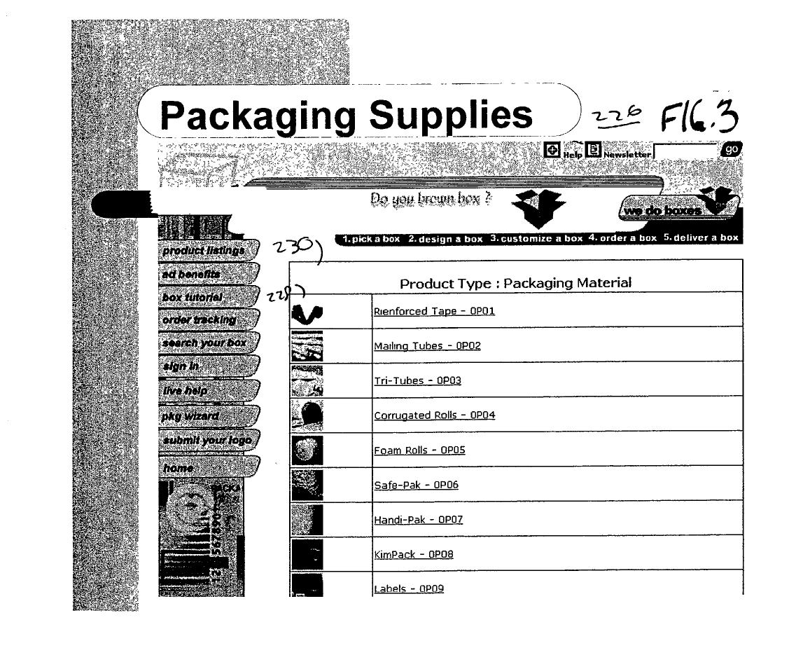

The Customer may be given the option of selecting from a number of packaging supplies from a packaging supply page 226, shown in FIG. 3. In one embodiment, each packaging supply 228 offered through the Customer Interface 16 can be listed in the packaging supply table 230.

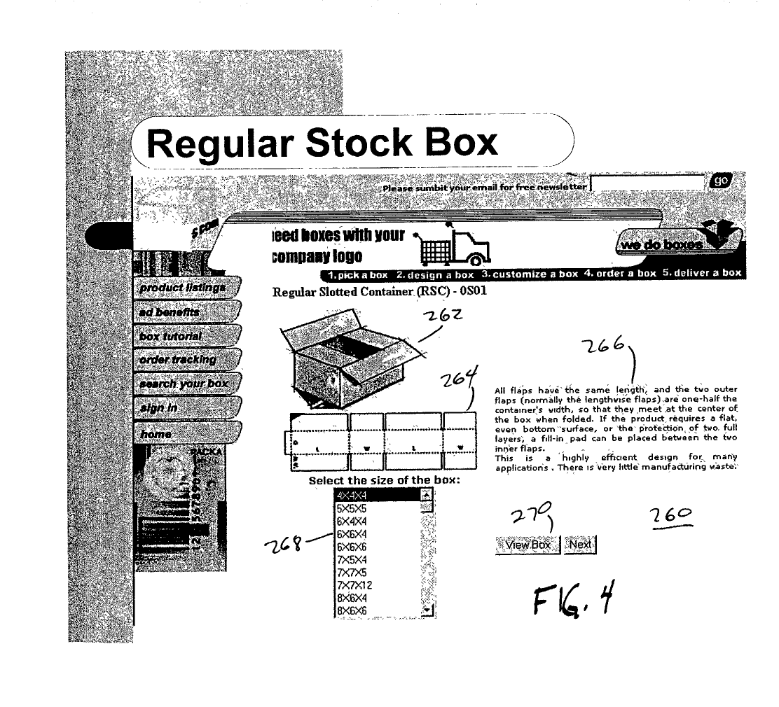

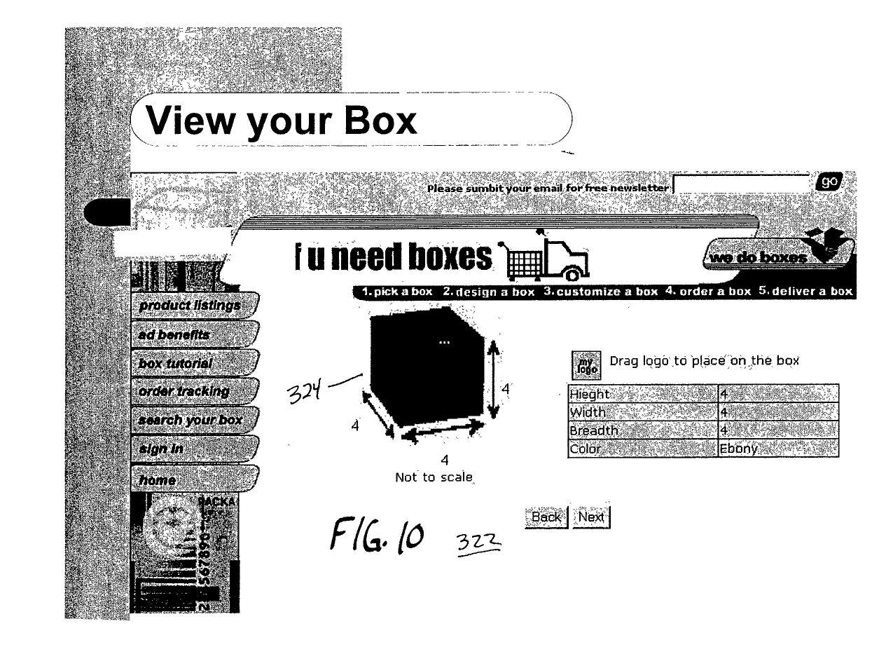

After selecting the desired type of packaging, the Customer 12 can then be presented with the option of selecting the size of the packaging, as illustrated in the sizing page 260 of FIG. 4. FIG. 4 illustrates both a mechanical drawing and a three-dimensional outlay of the selected package. In one embodiment, the sizing page can display a three-dimensional photograph or image of the package 262, a two-dimensional drawing of the package 264, for example, in the form of a mechanical drawing, a description of the desired package 266, and a variety of potential standard, or stock, sizes corresponding to the package 268. The Customer 12 may select a desired size from the variety of sizes corresponding to the package 268. In one embodiment, the sizing page 260 may include a “View Box” option 270, which allows the Customer 12 to view the selected package according to the chosen dimensions. An example of a View Box display page is generally shown at numeral 322 in FIG. 10. In addition, page 322 can include a “get CAD” feature to direct the user to a CAD utility where the logo or artwork would be placed (not shown) according to the customer's preference.

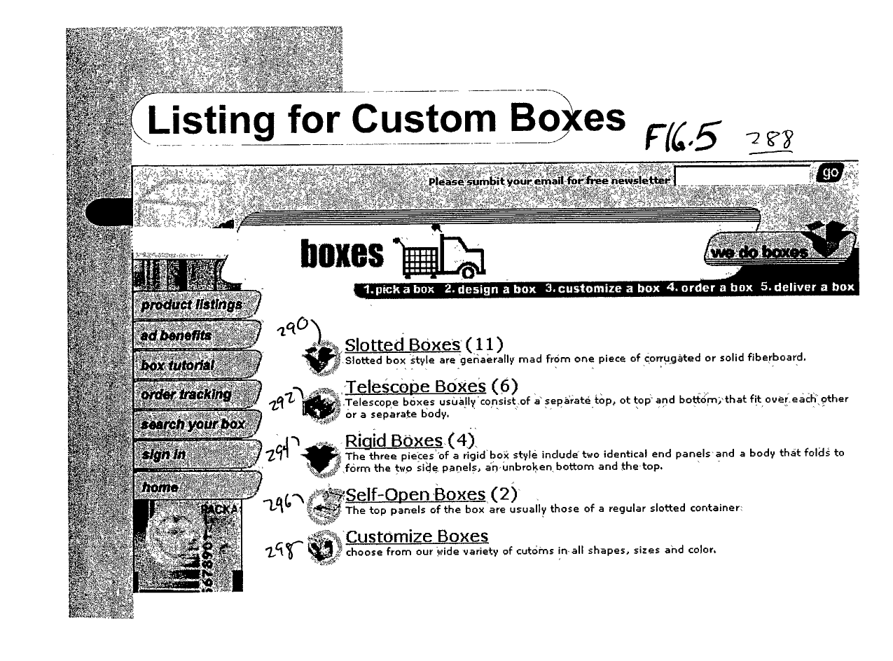

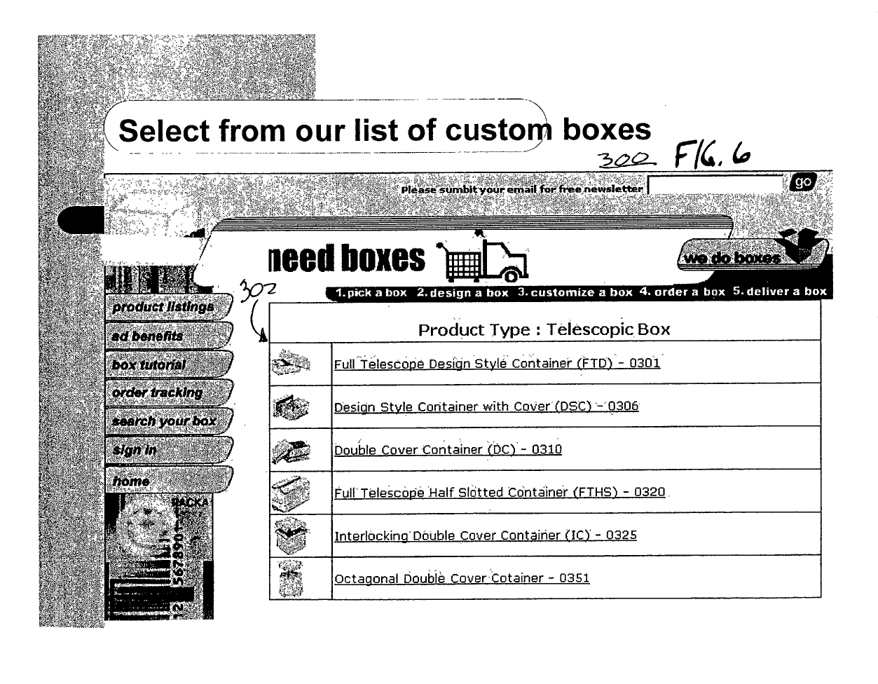

The Customer 12 may select to purchase a custom-made package, in which case the Customer 12 can be presented with a product listing page 288, as shown in FIG. 5. The product-listing page 288 can display various categories of custom-made packages offered by the system 10. For example, the product-listing page 288 can illustrate the categories of slotted boxes 290, telescope boxes 292, rigid boxes 294, self-open boxes 296 and customized boxes 298. Within each category, there can be a number of subcategories corresponding to the actual packages contained within that category. For example, in FIG. 6, the category of telescope boxes 300 is illustrated. The category of telescope boxes 300 itself can include a number of subcategories 302, describing various aspects of the chosen category.

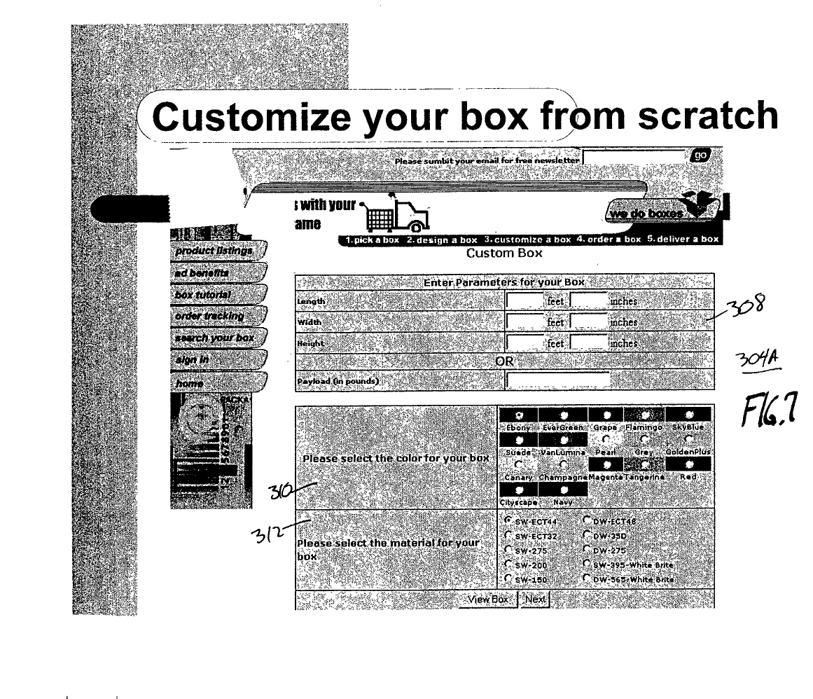

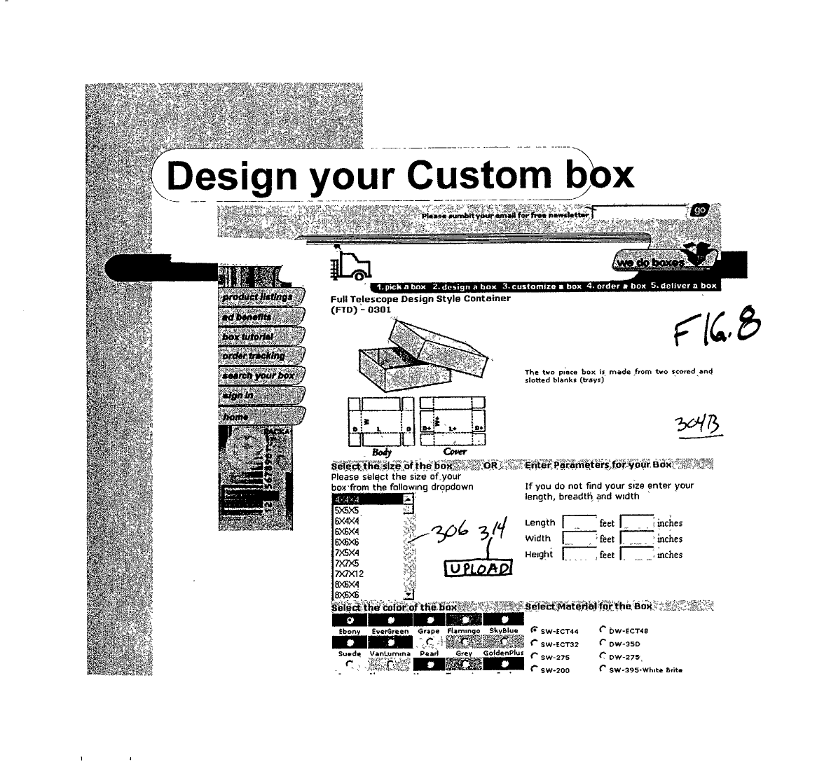

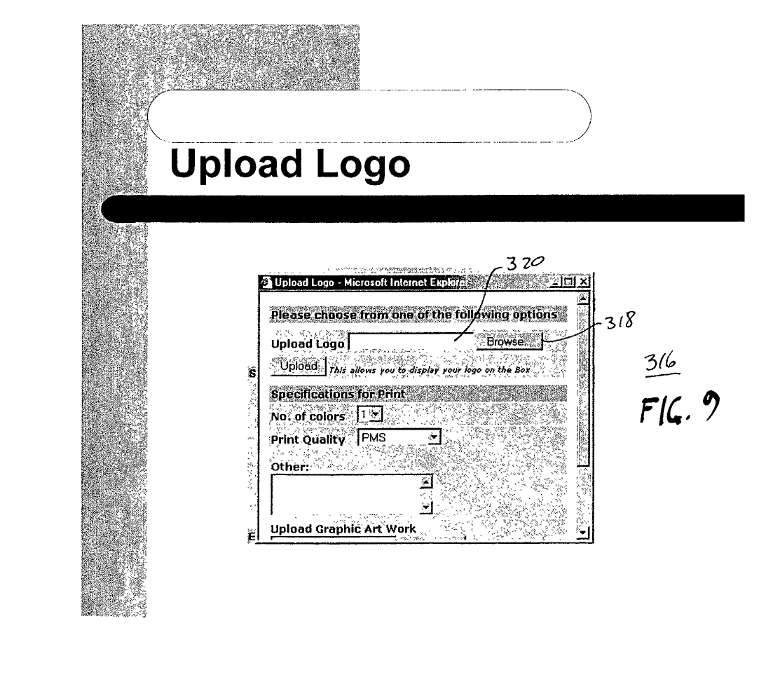

After selecting a particular custom-made package, the Customer 12 can be directed to a description page 304A and 304B, shown in FIGS. 7 and 8. From the description page 304A, B, the Customer 12 may select a number of variables relating to the selected package, including, for example, the size (which may be via the predetermined list 306 or manually entered 308), the color 310 or the material 312. Additionally, in FIG. 9, Customer 12 can have the option of uploading artwork, such as a logo, to be affixed to the selected package 314. If the Customer 12 selects such an option, the Customer 12 can be directed to an upload page 316, shown in FIG. 9. From the upload page 316, the Customer 12 may browse a personal logo file 318 (which may be kept on a Personal Computer or a magnetically-readable disk) and upload it to the Customer Interface 16 via the upload logo window 320.

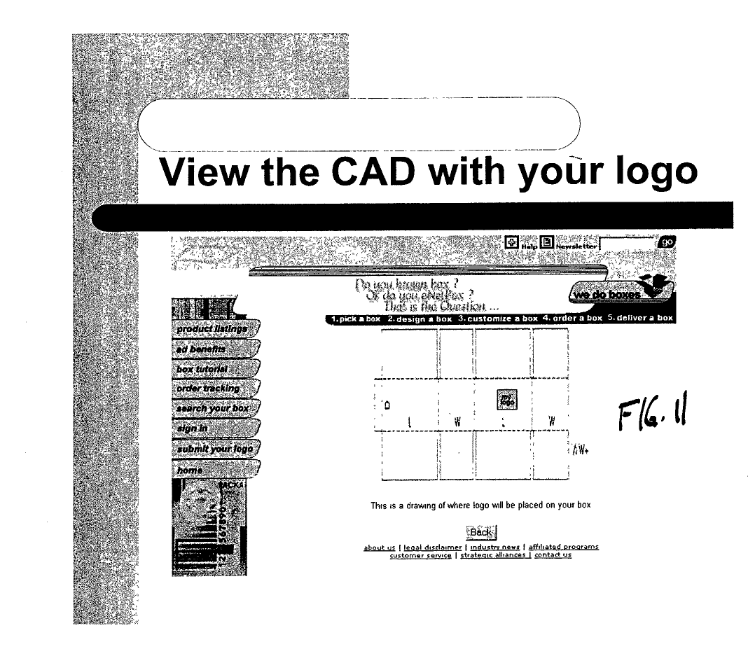

As is the case with the stock boxes, the Customer 12 may view the box via a viewing page 322, shown in FIGS. 10 and 11. In the case in which the Customer 12 has selected and uploaded a logo, the Customer 12 is given the opportunity to place the logo on the package in a desired location(s) 324. The Customer Interface 16 may record such information and may prepare an industry-specific drawing (i.e., Computer-Aided Design or other mechanical drawing) of the package with the logo shown as placed thereon, along with any other industry-specific standard information. The Customer Interface 16 may then send the information to the Manufacturer Interface 20. Once the Customer 12 selects the location of the logo, the remaining space on the package may be made available for advertising. The location of this space can be recorded by the Customer Interface 16 and sent to the Advertiser Interface 26. For example, a Customer 12 may choose one side of a package on which to place the logo of the Customer 12, but leave the other three sides of the package available for Advertisers 22. The mechanical drawing specific to the Customer 12 may be stored in the Customer's personal portfolio at a location which may be integral to or remote from the Interfaces (either the Customer Interface 16 or the Manufacturer Interface 26), along with other details and preferences of the Customer 12 which may be used in the Customer's later orders.

The process by which a Customer 12 may insert an advertisement logo is as follows: The Customer 12 may “drag” (as with a mouse or other computer peripheral device) the logo, as shown in FIG. 11, onto a desired location on the image of the package. At this point, the Customer Interface 16 can then record the coordinates of the logo as placed on the image of the package. The Customer Interface 16 can then translate the coordinates into a form capable of being recorded and noted onto a mechanical, or Computer-Aided Design, drawing of the package. The mechanical drawing may be generated and calculated dynamically by the Customer Interface 16 to conform to the specifications of the Customer 12, or may be chosen from stock drawings of standardized packages, which may be stored in a database. Additionally, the logo can be sized to fit proportionately on the package and on the drawings of the logo. The placement of the logo by the Customer 12 can be onto a virtual image of the package. Thus, to accurately place the logo in a manner understood by the Manufacturer 20 requires a translation of the virtual image onto a mechanical (or industry-standard) drawing. Additionally, the three-dimensional image of the package may be rotated, or otherwise moved, to allow the Customer 12 to place the logo on any particular side of the image, thus making the package as customizable as possible, to the satisfaction of the Customer 12.

In one embodiment, the Customer 12 may be permitted to approve and verify the placement of the logo, such as through the dynamic generation of a flat-screened (or two-dimensional) version of the side of the package containing the logo. The Customer 12 may also be given the opportunity to re-size, reposition or replace the logo on the package as the Customer 12 sees fit. Upon confirmation of the logo by the Customer 12, the position of the logo may be stored in the Customer Interface 16, where it may be referred to in future uses of the logo by the Customer 12.

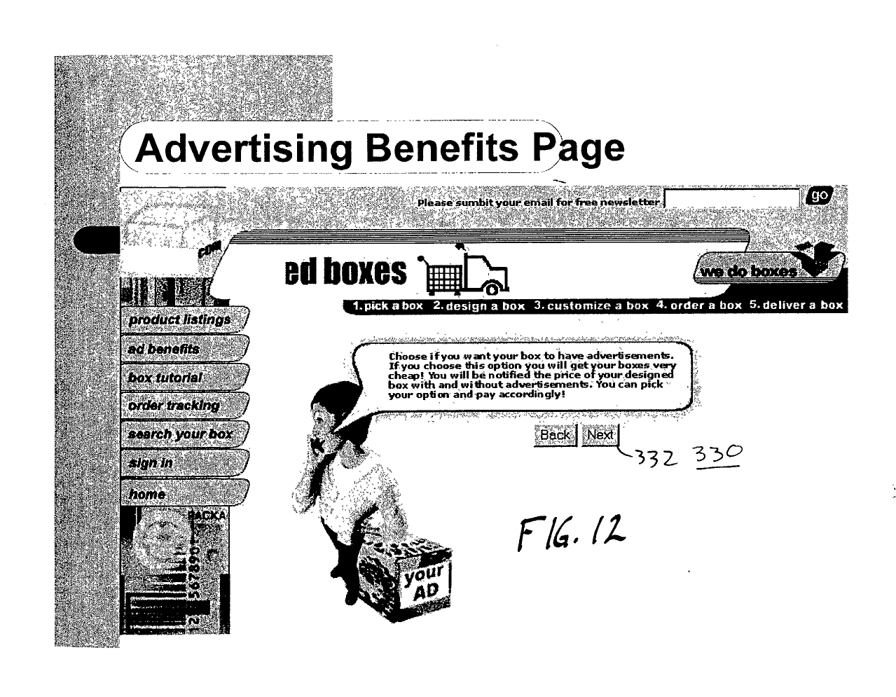

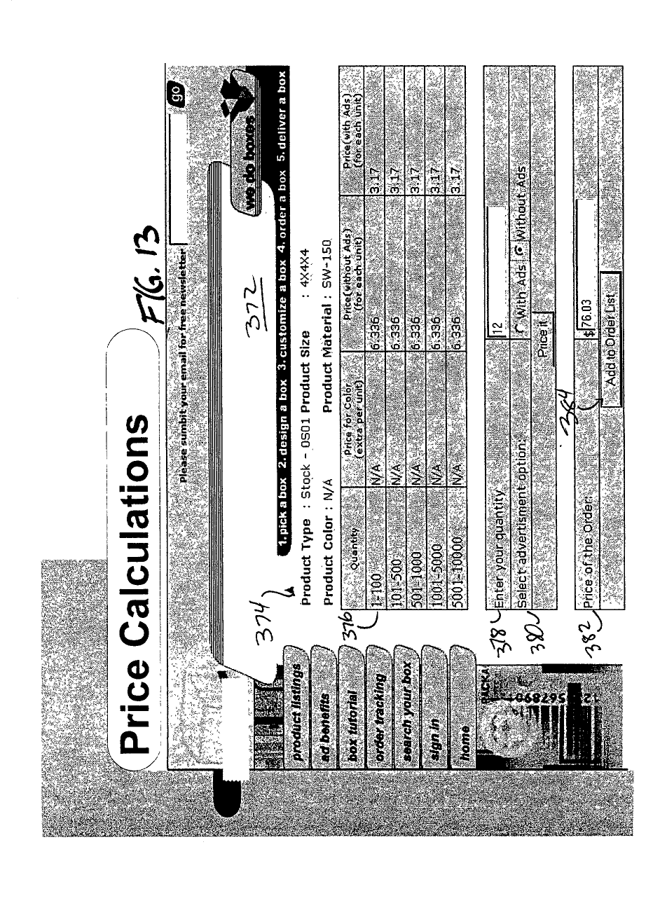

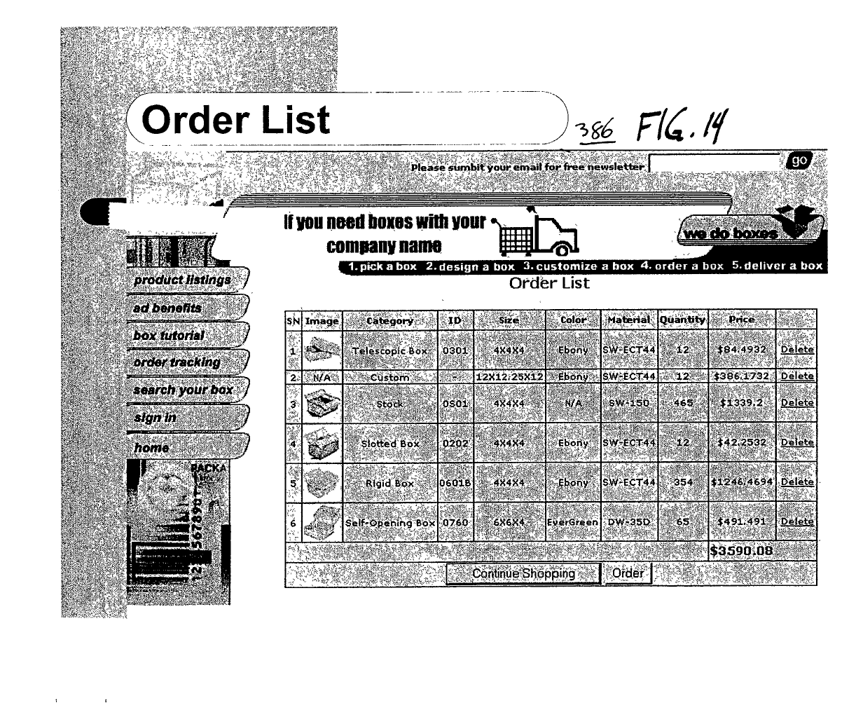

The Customer 12 can elect to choose whether a selected box order will include advertisement. The advertising benefits page 330 is shown on FIG. 12. In the event the Customer 12 wishes to investigate further the possibility of comparing the price of the design box with them without advertisement the customer can indicate such a desire 332. In such a case a price calculations function, illustrated in FIG. 13 may be used. Upon selecting a package, the Customer 12 can then be directed to a pricing page 372, shown at FIG. 13. The pricing page 372 displays the package information 374 as selected by the Customer 12. Additionally, the pricing page 372 may also include a pricing table 376 that displays the variation in prices associated with respective quantities. The Customer 12 can be prompted for an input 378 indicating a quantity of packages the Customer 12 desires to order. Additionally, the Customer 12 can be prompted for an input 380 indicating an intention whether to include third party advertisements on the Customer's package. Upon receiving the inputs, the Customer Interface 16 determines the cost of the order without advertising, and displays 382 such cost for the Customer 12. The Customer Interface 16 may also determine the cost of the order with advertising based on input from the Advertising Interface 26. Alternatively, the Customer Interface 16 may use a predetermined or dynamically calculated reduction factor to reduce the cost if the Customer selects the advertising preference. The Customer 12 can then be given the option 384 to add the particular pricing to the Customer's order list 386. One embodiment of the order list 386 is shown generally at FIG. 14.

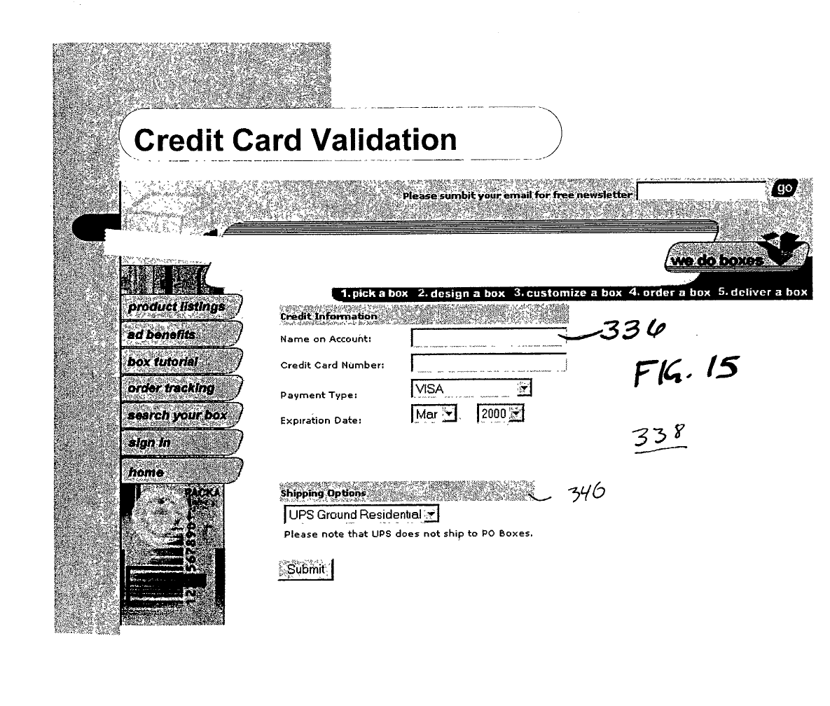

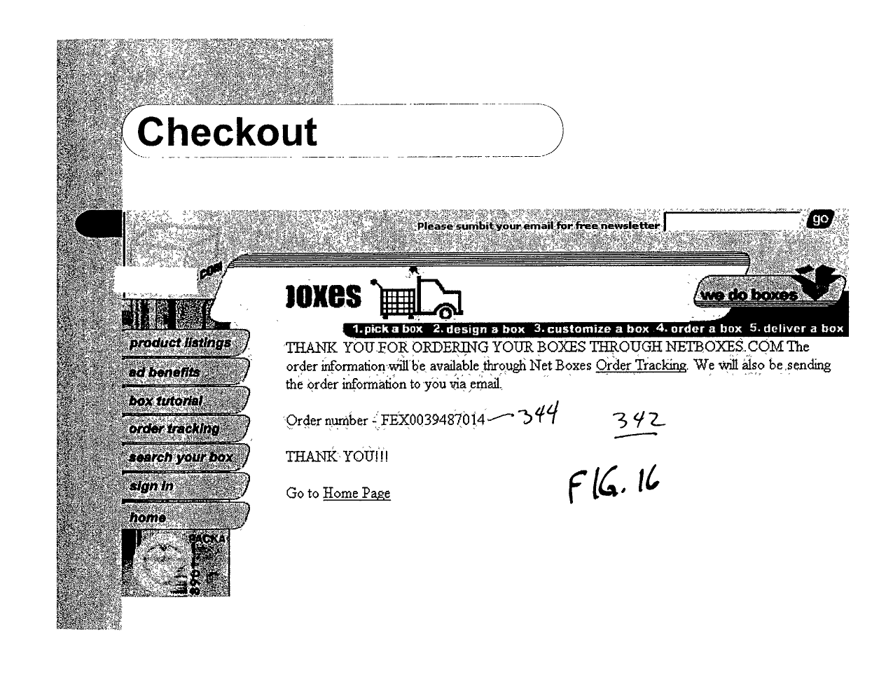

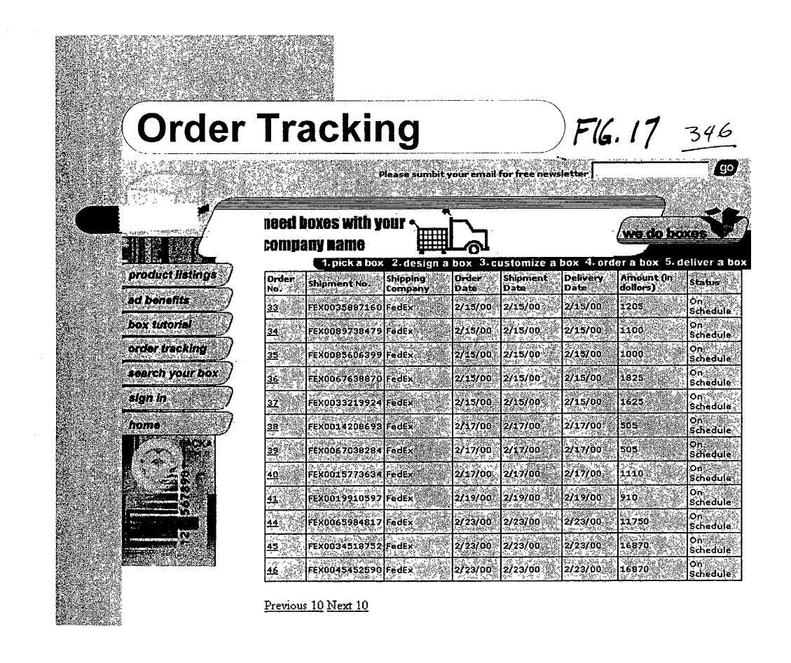

After selecting the above information, the Customer 12 can be directed to a payment page 338, shown in FIG. 15. At the payment page 338, which in the illustrated example is a credit card validation page, the Customer 12 can input information relating to the payment method used to pay for the order. In one embodiment, the payment method may be via credit card, but may include any other similar method of payment, such as, for example, a personal or business check. An example of inputting information relating to credit card payment is shown in FIG. 15 at reference numeral 338. Additionally, the Customer 12 may enter a preferred method of shipping, via the shipping options window 340. After receiving the required information, the Customer 12 can receive a confirmation page 342, shown at FIG. 16, which lists an order number 344 for future reference, via the order-tracking page 346 (FIG. 17).

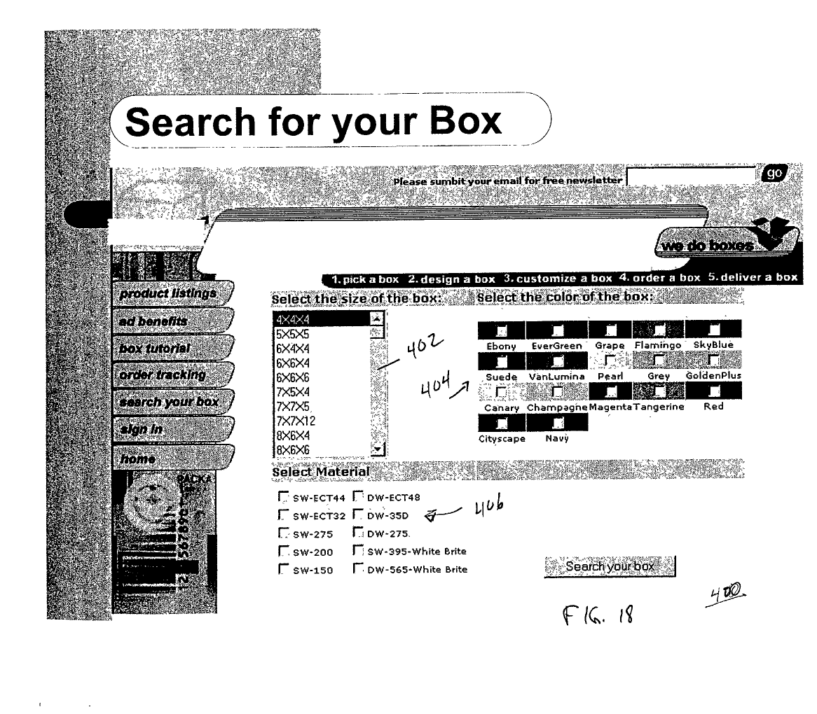

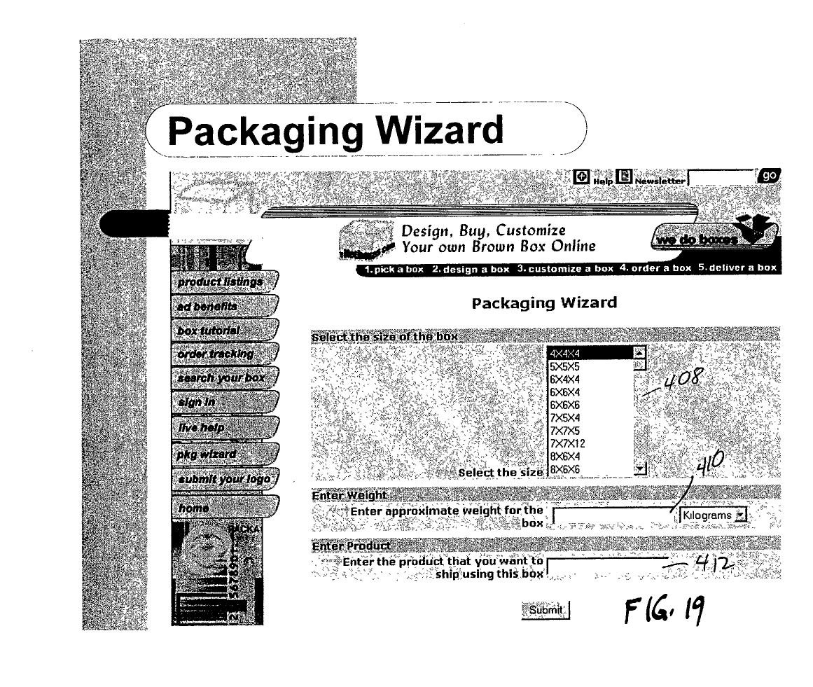

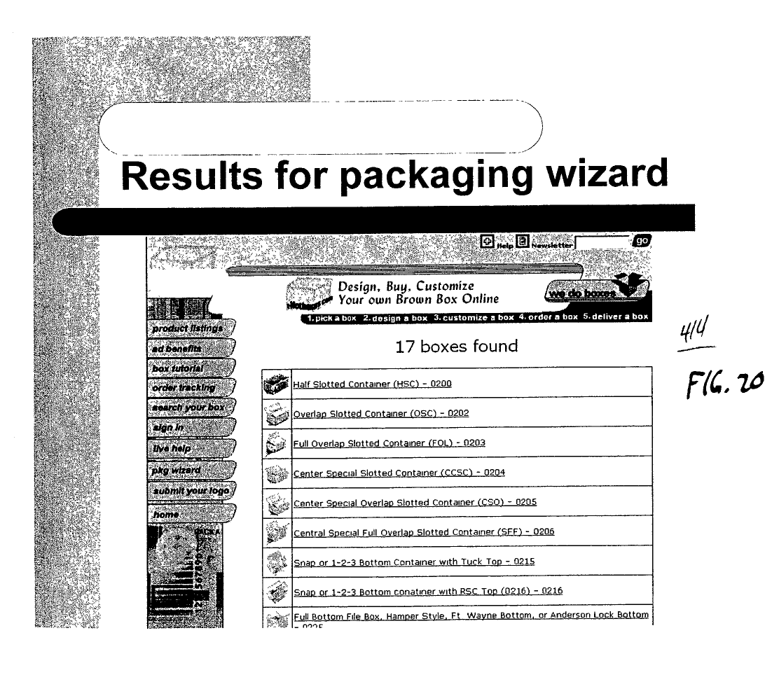

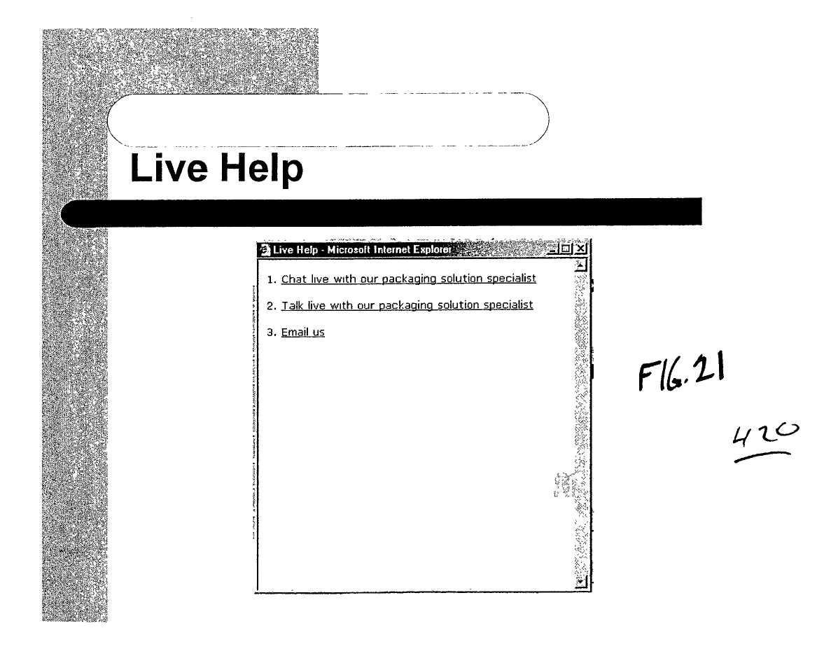

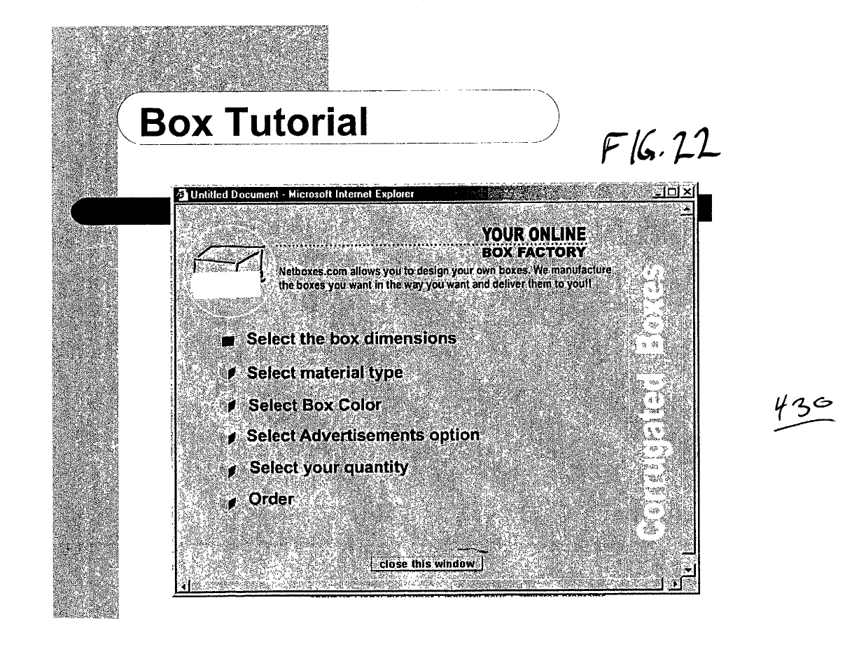

Additional functionality can be provided on a search page 400 where Customer 12 can determine the status of a specific order as shown in FIG. 18 by completing fields directed to specific attributes of the order such as box size 402, box color 404 and box material 406. The page illustrated in FIG. 19 can be used to assist a Customer 12 in designing a customized box online. In this respect the utility accepts customer input in regards to package size 408, and/or an approximate weight of the product 410 and identification of the product to be shipped in the box 412. For example, a known weight of liquid, such as water, can be used to calculate a volume of package to be supplied. An illustrative example of a packaging wizard result is shown on a results page 414 illustrated in FIG. 20. In addition, a “Help” page 420 and a box tutorial utility page 430 can be provided as shown in FIGS. 21 and 22 (pages 402 and 404). The source code for one embodiment of the functionality of the Interface 16 is attached at Appendix A.

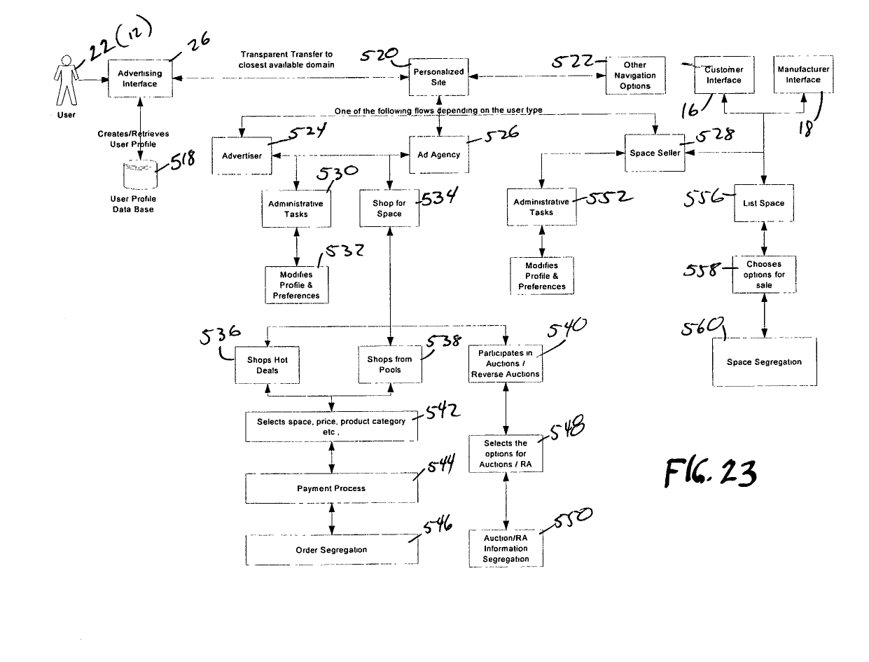

FIG. 23 illustrates an embodiment of a method for placing an advertisement onto a package via the Advertisement Interface 26. The first time that a user, which can be an agency, space seller or Advertiser 22 accesses the Interface 26 an opportunity can be provided to create a new user profile. In the event that user 26 is a repeat user, a user profile can be retrieved from a user profile database 518. In the event that the Interface 26 is part of a distributed network or the like, the user 22 can be transferred to the closest available domain site. The user 22 can access a personalized site or Interface 520. Other navigation or communication options 522 can be provided.

Navigation from site 520 can be made dependent upon the user type. The user type may be an advertiser 524, an ad agency 526 or a space seller 528. If the user is an advertiser 524 an opportunity to perform administrative tasks 530 can be provided, an example of which is the opportunity to modify the user profile and preferences 532. The advertiser 524 may interface with an ad agency 526. The advertiser 524 or ad agency 526 may shop for space 534. Shopping for space 534 can be performed by accessing a “hot deal” 536 portion of the site, a “pool” 538 portion of the site or electing to participate in an auction or reverse auction portion of the site 540.

The advertiser 524 or ad agency 526 can select space, price, product category 542 and so on. Once the transaction or selection process 542 is complete, the advertiser 524 or ad agency 526 can be directed to the payment process 544 and order segregation process 546, which can be the same as, or similar to, previous payment and segregation processes.

With respect to the auction process 540, the advertiser 524 or ad agency 526 can select the options for the auctions or reverse auctions 548, after which an information segregation process can occur 550.

If the user is a space seller 528 an option is provided to perform administrative tasks 552 which can include the modification of the user profile and preferences 554. The space seller 528 can be directed to a space listing provision 556. The seller 528 can choose options regarding the sale of advertising space 558 after which, a space segregation process can occur 560. The space seller 528 can also be directed to the Customer Interface 16 or the Manufacturer Interface 18.

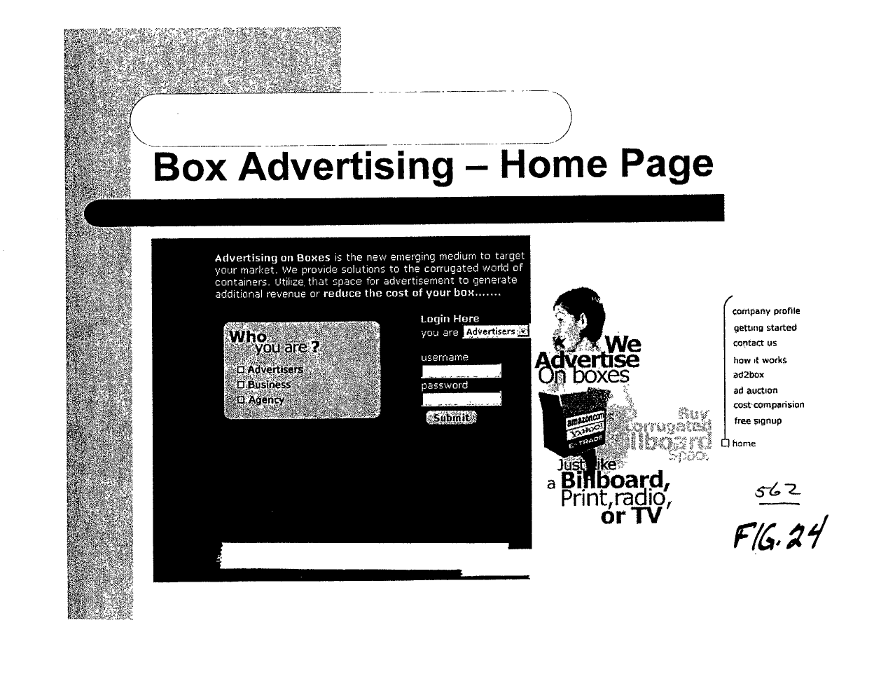

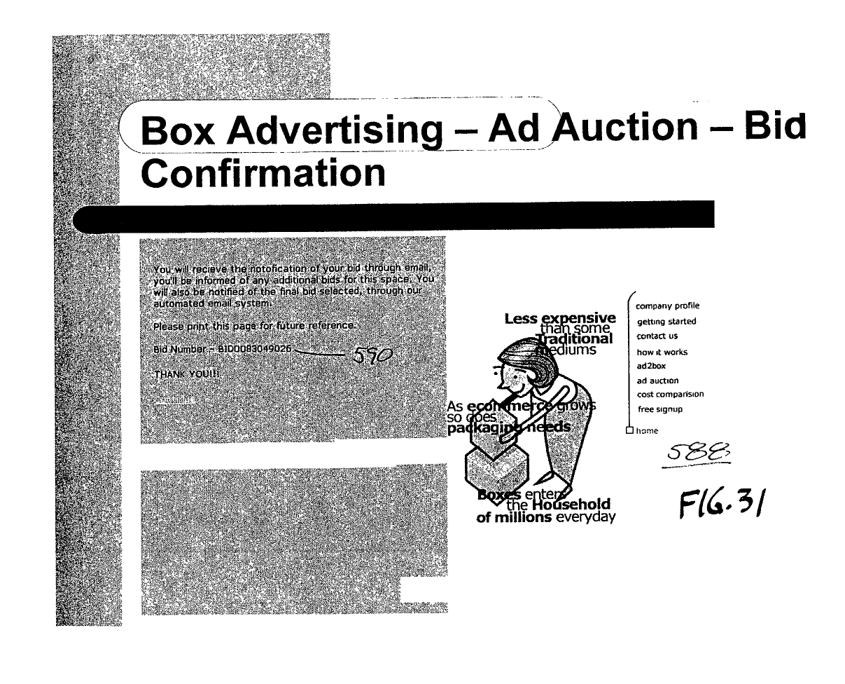

FIGS. 24-31 illustrate a method for coordinating the placement of advertising on corrugated containers via the Advertising Interface 26. At the onset of the process, a user 22 can be presented with a login or commencement page 562. The commencement page 562 may, as shown in FIG. 24, include a World Wide Web (WWW) page on the Internet, or, in the alternate can include any suitable means of communication to facilitate interaction between the user 22 and the Advertising Interface 26. The interaction means can include, but is not limited to, electronic or conventional media, such as, a computer connection, telephone connection, a wireless connection, e-mail and instant messaging. The user 22 can be one or more of an Advertiser (22) 524, a Business 528 and an Agency 526. Users are presented with the opportunity to login as an advertiser, a business or an agency using a user name and password as is conventional.

The commencement page can enable a user 12 to enter preferences for the advertisement via the Advertising Interface 26. In the alternate, the advertisement commencement page 562 will provide an opportunity for customers, i.e., businesses 528 wanting to sell space on their packages to advertisers. In this manner, the customer is provided the opportunity to offer space on their packages to those advertisers wishing to place an advertisement. In the event where the customer offers billboard space on the packaging to advertisers on the advertiser Interface, the customer may enter, at the Advertising Interface 26 specifics regarding the product. The specifics can include number of packages, space available, the size of preferred advertisement, the size of the package, product categories and the like. In addition, the customer may also include customer preferences. Customer preferences (or order preferences) can include geographic location, package size, product category (for example, soft drinks), service category (for example, temporary labor), industry category (for example, fast food) income category, ethnic category and age category.

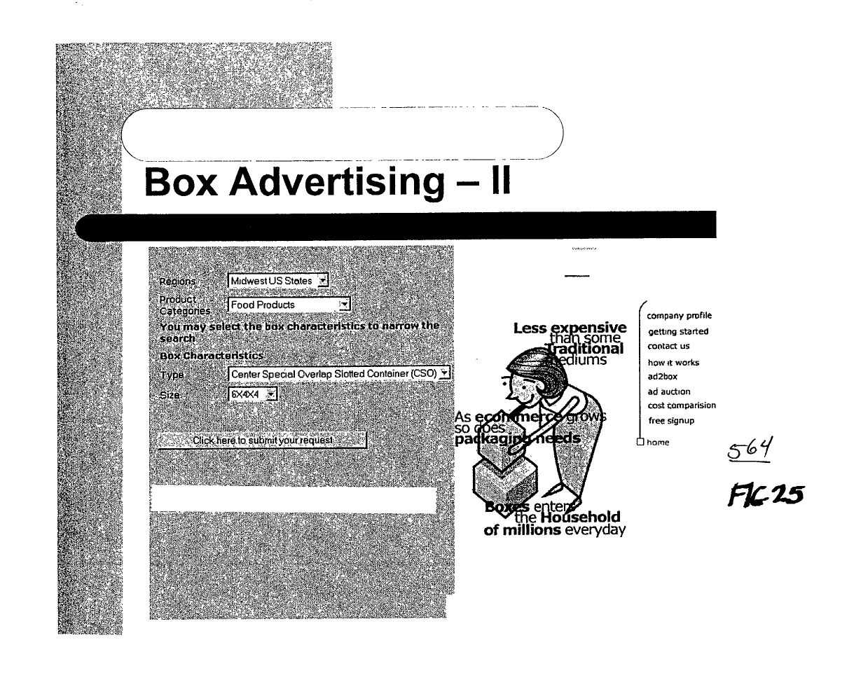

As shown in FIG. 25, an Advertiser can specify a preferred and geographic region on an Advertiser input page 564. In this matter, the Advertiser can limit distribution of the boxes including the user advertisement to a specified targeted geographic area. The Advertiser may also specify a product category. Thus, the Advertiser can specify a type of commercial product upon which the advertisement is to be placed. In addition, the Advertiser can specify physical characteristics of the box upon which the advertisement is to be placed. For example, the Advertiser can specify the type of box and the size of the box. Further, the Advertiser can be prompted to target their advertising during a specified time span.

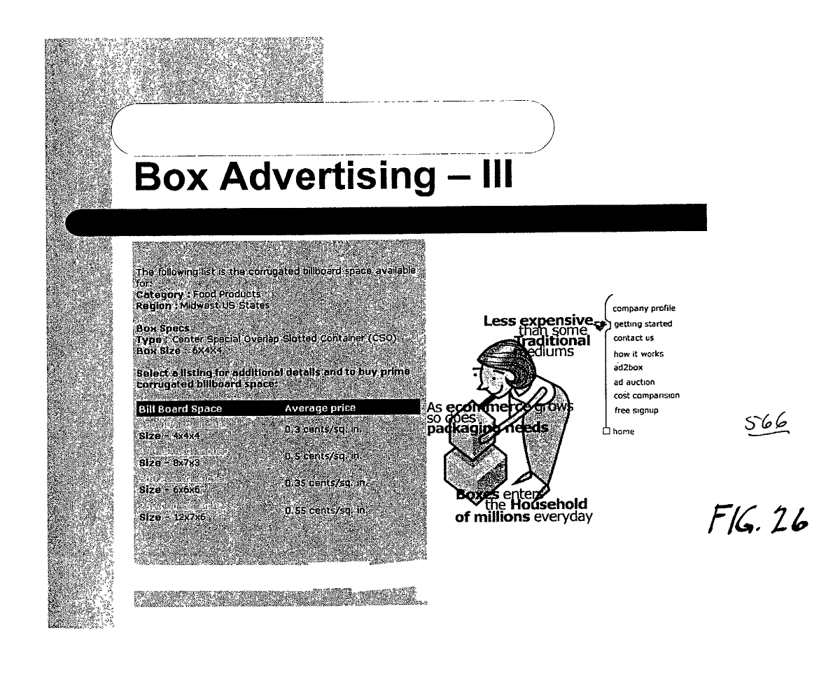

After the Advertiser enters one or more preferences as illustrated in FIG. 25, the Interface 26 can match the selected preferences with boxes having available billboard space meeting the selected criteria. As shown in FIG. 26, the advertiser preferences can be summarized on a listing page 566. The page 566 can include a plurality of individual listings that meet or exceed the advertiser criteria or preferences. The listing can present the amount of container billboard space available with respect to each of individual listings. The listing can include the box size. In addition, the listing page can include a price. The price can be expressed as a cost per square inch of billboard space. Other price structures are contemplated, such as a cost per side of the box, a cost per entire box and so on.

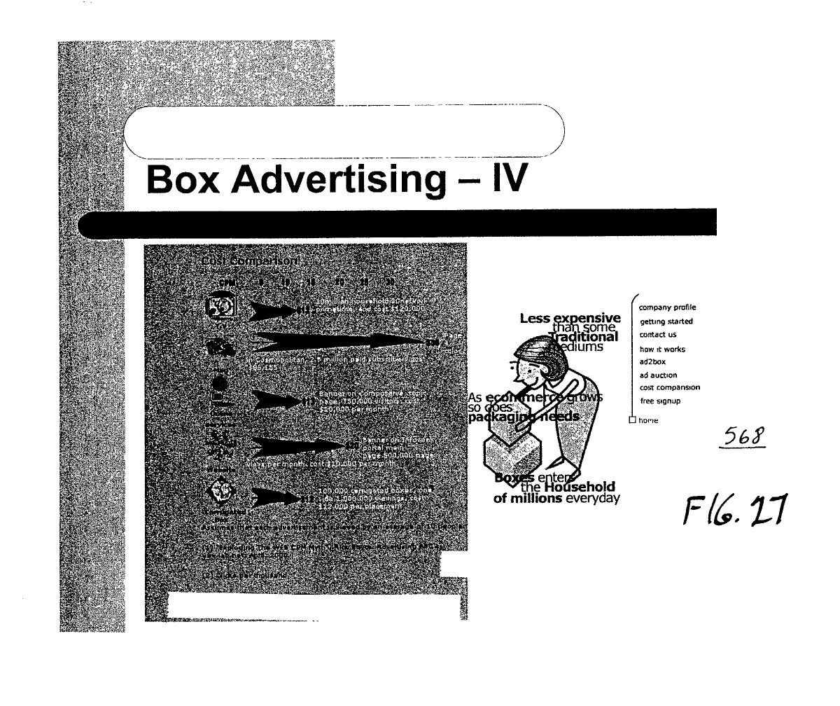

As shown in FIG. 27, the Advertiser 22 can be taken to a cost comparison page 568. The cost comparison page can display the relative cost of advertising based on various assumptions. For example, the page can display the relative cost of advertising between television advertisement, magazine advertisement, online services, Website advertising and advertising on corrugated boxes.

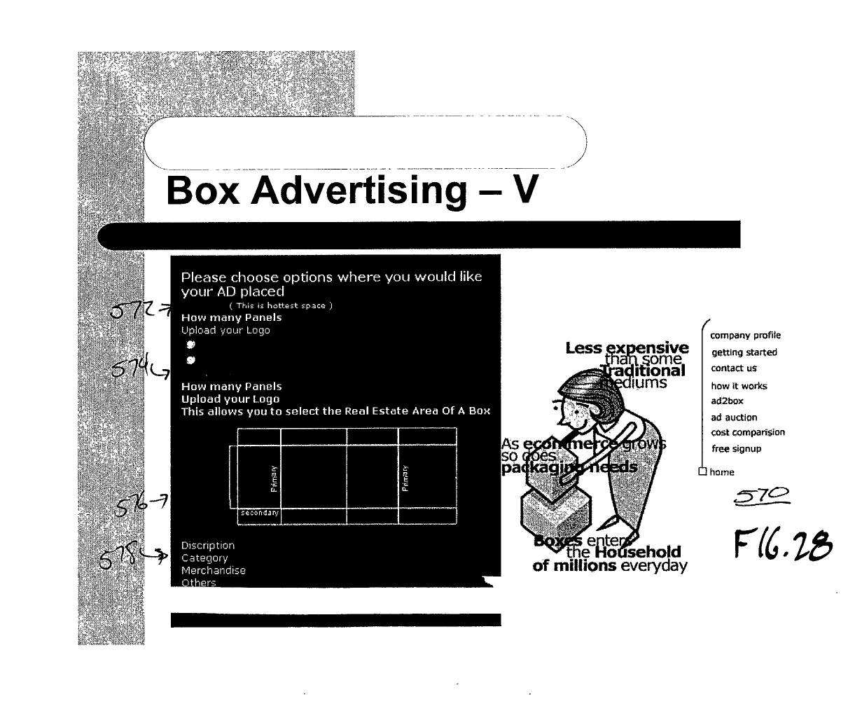

As shown in FIG. 28, the Advertiser can be displayed a further page 570 which enables the advertiser to place the advertisement. The Advertiser may indicate a desire to place the advertisement in the primary location 572. The primary location may be indicated on a depicted box selected by the Advertiser on a previous page. Further, the Advertiser 22 may indicate a desire to place the advertisement in a secondary location 574. The secondary location 574 may be indicated on the same depicted box. The selection can occur when the user clicks on the word primary 572 or secondary 574 on the page 570 or on the depicted box 576 or other suitable selection methods. The Advertiser 22 can indicate how many panels on which the advertisement is desired to appear. The Advertiser 22 can be provided a means to upload a logo or other advertisement.

Other options include the provision to provide a description, indicate a category and indicate a merchandise preference 578.

Further, Advertiser may be permitted to approve and verify the place the logo, such as through the generation of a two-dimensional or three-dimensional depiction of the package containing the logo Generation of the image can be performed by accessing a graphics module, including a CAD/CAM, or the like utility (not shown). The Advertiser 22 may also be given the opportunity to change the size, reposition or replace the logo on the package in real time. When the Advertiser is satisfied with the placement of the advertising or logo, the Advertiser may store the logo and position thereof in an associated database. The Advertiser 22 may retrieve the stored logo and position for future use.

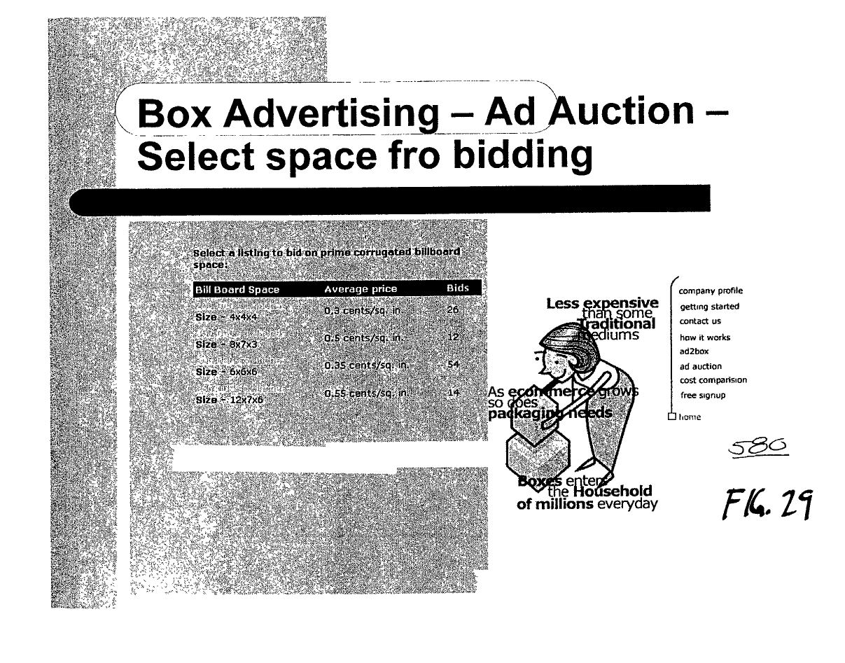

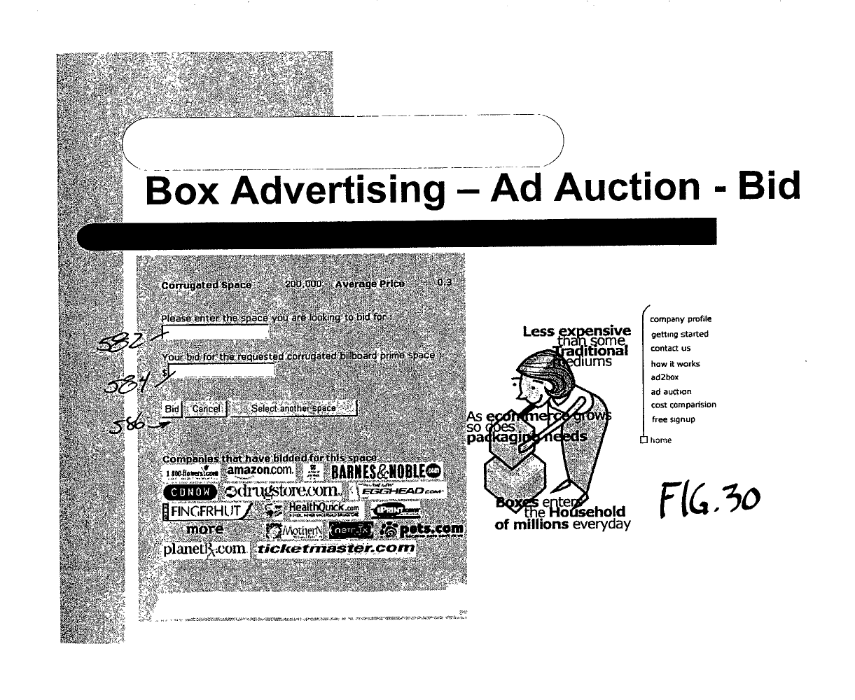

A further feature of the Advertising Interface 26 can be an advertising auction depicted at FIGS. 29-31. As shown in FIG. 29, a space selection page 580 provides a listing of corrugated billboard space on which an advertiser or agency can place bids. The Advertiser 22 can select one or more of the items on the list. As shown in FIG. 30, the Advertiser 22 can then enter the amount of space 582 and a bid 584 for that space. The Advertiser 22 can place the bid, cancel the bid or select other space upon which the bid is to be placed 586. The Advertiser 22 can be presented with a bid confirmation page 588 including a bid number 590. The source code for one embodiment of the functionality of the Advertising Interface 26 is attached at Appendix B.

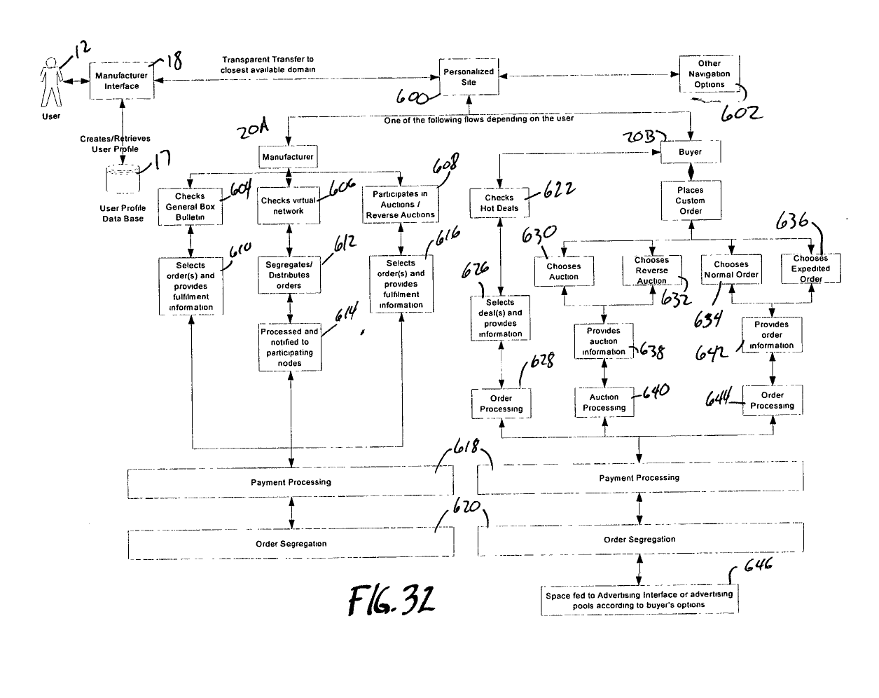

FIG. 32 illustrates an embodiment of a method for ordering and manufacturing a package. The method can include use of a Manufacturer Interface 18 or other communication system. The first time user 12 accesses the Manufacturer Interface 18 an opportunity is provided to create a new user profile. In the event that user 12 is a repeat customer, a customer profile can be retrieved from a user profile database 17. In the event that the Interface 16 is part of a distributed network or the like, the Customer 12 can be transferred to the closest available domain site. The Customer 12 can access a personalized site or Interface 600. Other navigation or communication options 602 can be provided. A user or Customer 12 can be a Manufacturer 20A or a Buyer 20B.

Manufacturer 20A can access a general box bulletin 604, can access a virtual network 606, and can participate in the auction or reverse auction 608. At general box bulletin 604 Manufacturer 20A can select an order, or more than one-order and provide fulfillment information 610. At virtual network 606 the Manufacturer can segregate and distribute orders 612. The orders can be processed in, and notified at participating interfaces or nodes 614. If the Manufacturer participates in an auction or reverse auction 608 the Manufacturer can select one or more orders and provides fulfillment information 616.

After processing steps 610, 614 and 616, payment-processing 618 and order segregation 620 processes can be provided. As in the above, payment processing in order segregation processes can be separate, distributed processes or can be a centralized function that operates in connection with several interfaces or nodes.

Buyer 20B can access a “hot deals” page or portion 622 of the Interface 18, which can include overrun stock, or the like, which may be discounted. The Buyer 20B can select or order a product or products and provide appropriate information 626. The order can then be processed 628.

The Buyer 20B can also place a custom order 624, by choosing an auction 630, choosing a reverse auction 632, choosing a normal order 634, or choosing an expedited order 636. If the Buyer 20B chooses one of auction 630 or 632, auction information can be provided 638 and the auction can be processed 640. If the Buyer 20B selects to choosing normal or expedited order 634, 636 order information can be provided 642 and the order can be processed 644.

After each processing step 628, 640 or 644 a payment processing step 618 and an order segregation step 620 can be provided. Space available for third party advertising can be sent to advertising pools depending on the Buyer's options 646.

FIG. 33 illustrates another embodiment of a method for ordering and manufacturing a package via the Manufacturer Interface 18. In FIG. 33, the Customer 12 can enter an order commencement “page” 648. The order commencement “page” 648 may comprise a World Wide Web (WWW) page on the Internet, or, alternatively, any other satisfactory means of providing an interaction between the Customer 12 and the Manufacturer Interface 18, such as, for example, a telephone communication, facsimile, email, instant messaging, wireless communication or the like. Upon entering the order commencement “page” 648, the Customer 12 may log in by entering input information at the login prompt 650. The source code for one embodiment of the functionality of the Manufacturer Interface 18 is attached at Appendix C.

Additionally, FIG. 33 illustrates an embodiment of a Bulletin Board 36, in accordance with the present invention. The Bulletin Board 36 contains a table 652, which shows a listing of orders, industry surplus items and materials that have been posted on the Bulletin Board 36. For example, there is shown an order of 2500 slotted boxes that are requested to be shipped to Wisconsin, Indiana. A merchant (i.e., Manufacturer 20) may browse these listings, and submit bids for the products located on the Bulletin Board 36. Users may sign up for access to the Manufacturer Interface 18 at the sign up region 654. Unregistered Users may merely browse the listings, but, in one embodiment, cannot access order details until submission of user information, thereby becoming a registered user.

FIG. 33 can additionally list an order initiation date and a closing date for the bidding process. The Customer Interface 16 can generate the order date 656 and the closing date can be generated by the Interface 16 as a function of the order date 656. This provides the Manufacturers 20 with notice as to when the bidding process both opens and closes. Additionally, actuating listing tab 658 can provide the Manufacturer 20 with a listing of all bids placed for a particular order. One embodiment of a listing page is shown as reference numeral 660 in FIG. 34.

Additionally, the Manufacturer 20 may initiate a search of open orders based on a number of criteria, such as, for example, time period of bid, type of package, place of shipment, etc. This search may be initiated by accessing a search button 662.

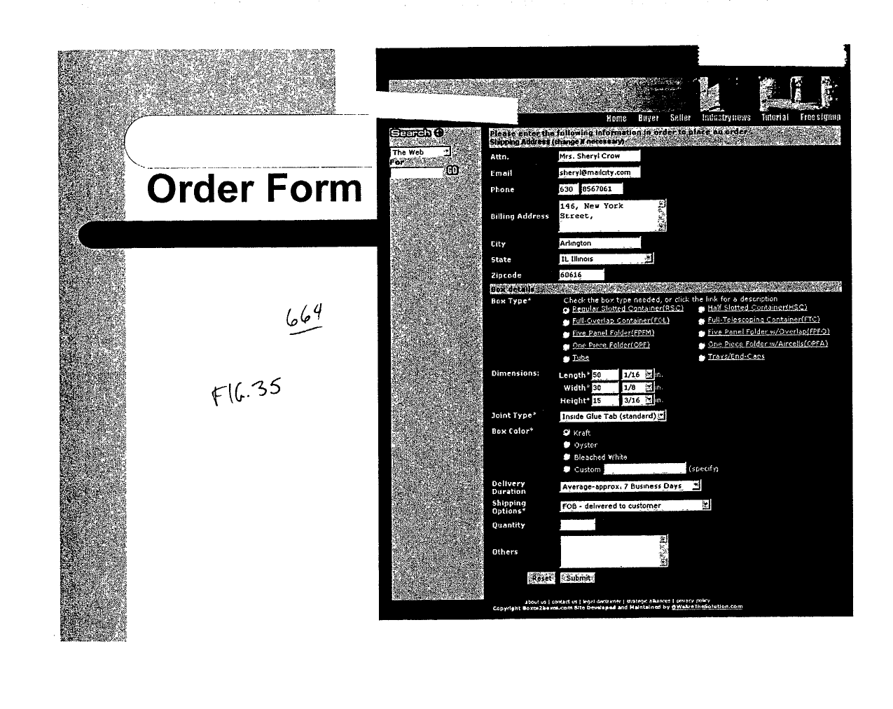

Shown in FIG. 35 is an order form 664. Upon inputting the required login information and entering the interactive aspect of the Manufacturer Interface 18, the Customer 12 can be then directed to the order form and information page 664, as shown in FIG. 35. At page 664, the Customer 12 can be prompted to enter general information, as well as order information. For example, the Customer 12 can enter the shipping address of the Customer 12 in a table or fields as shown and similarly can enter order details concerning package type, package size, package color, etc.

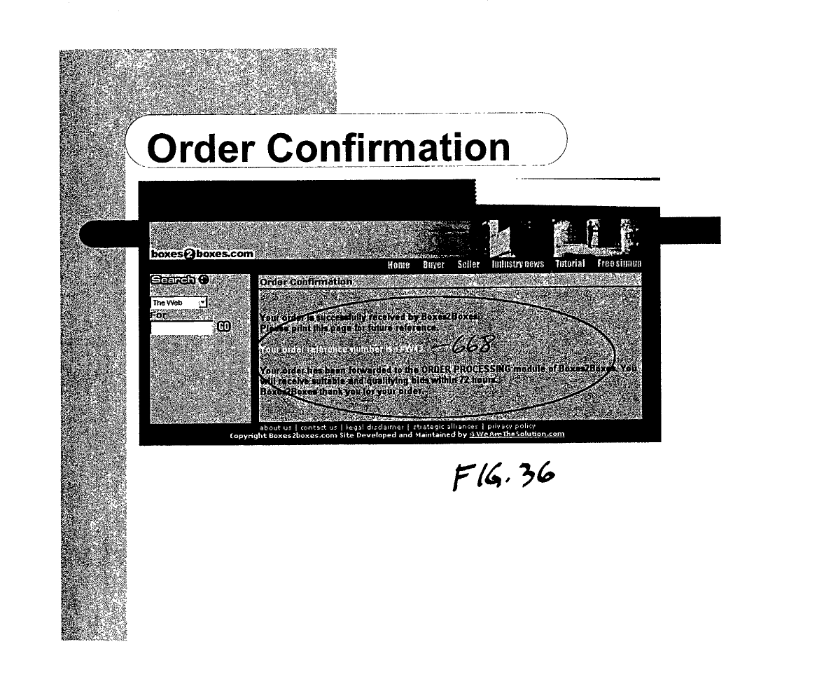

Once the Customer 12 submits the information entered in the information page 664, the Customer 12 can be provided with a confirmation message (corresponding to the confirmation of the order), which is shown in FIG. 36 as a confirmation page 666. Also shown in the confirmation page 666 of FIG. 36 is a Customer order reference number 668. At this point, the order can be forwarded for payment processing 618 and sorting and/or segregating 620. Manufacturers 20 can be notified within the geographic region concurrent with the Customer's 12 geographic region. Additionally, the order can be forwarded and displayed on the Bulletin Board 36, as is shown in FIGS. 33, 34. After the submission of the information by the Customer 12, any Manufacturer 20 who receives the order may respond to the order. Alternatively, any Manufacturer 20 may respond by entering the Bulletin Board 36 and viewing the entries.

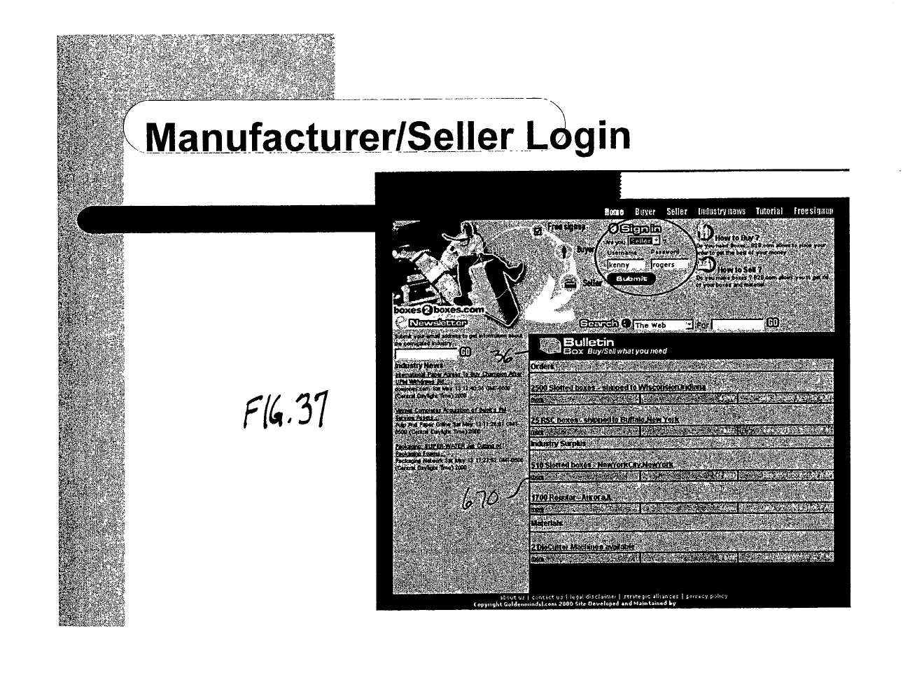

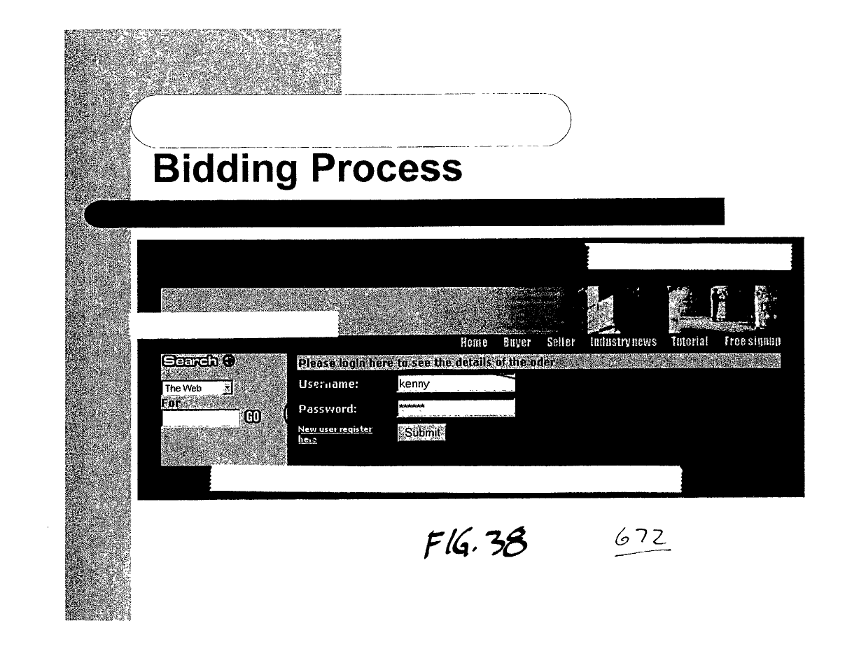

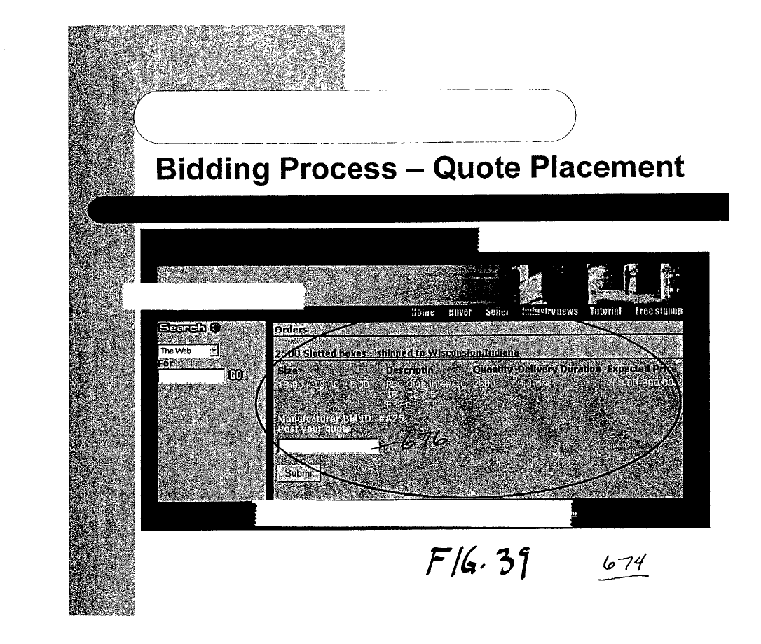

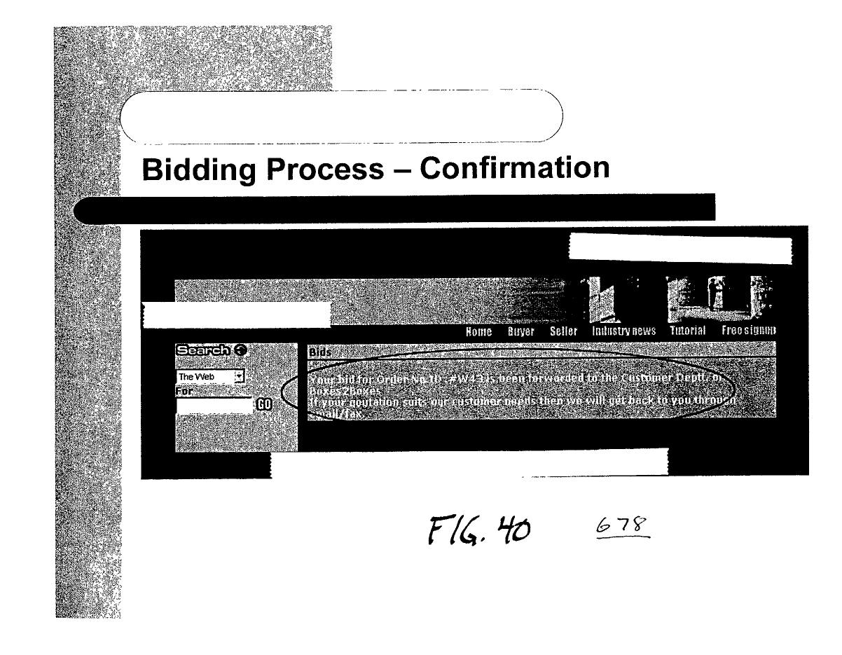

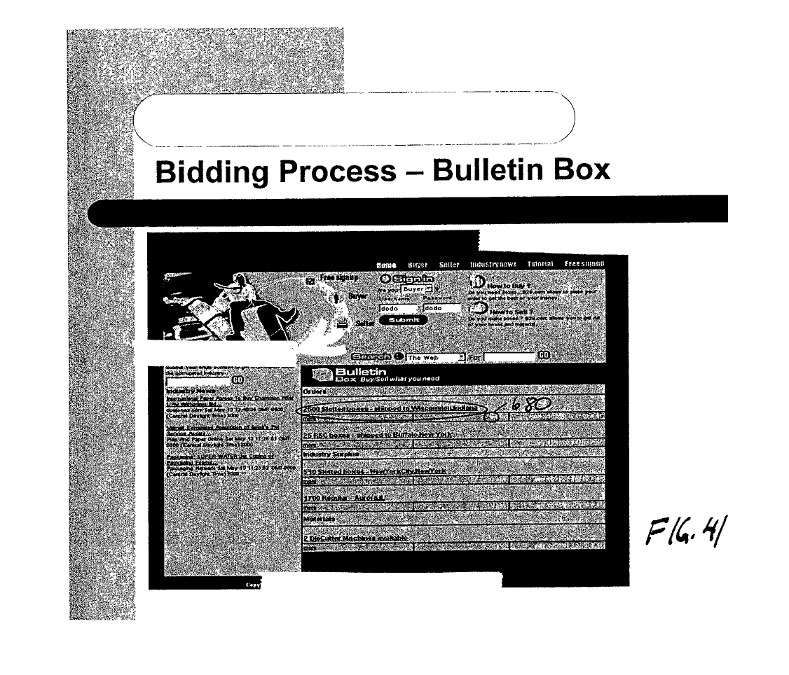

FIG. 37 illustrates a login screen for Manufacturer or Seller 20. The page illustrated can include a Bulletin Board listing of various orders 670. If a Manufacturer 20 wishes to respond to an order placed on the Bulletin Board 36, the Manufacturer 20 can enter login information on a Manufacturer login page 672, shown as FIG. 38. After entering the Bulletin Board 36, the Manufacturer 20 may then view the order information and details on an order information page 674, as shown in FIG. 39. If the Manufacturer 20 wishes to bid on the order, the Manufacturer 20 inputs a quote or bid in the bid region 676. Such bids may necessarily include a delivery cost component. The Manufacturer Interface 18 can then receive the bid, and a confirmation page 678 can be provided to the Manufacturer 20 (FIG. 40). Additionally, on the Bulletin Board list or table (as shown in FIG. 41), the bid is reflected at a bid number indicator 680.

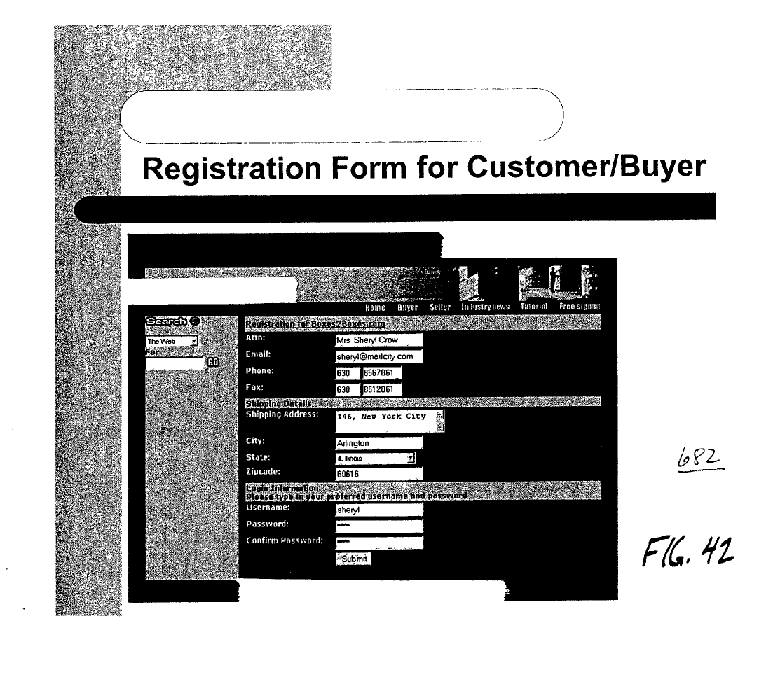

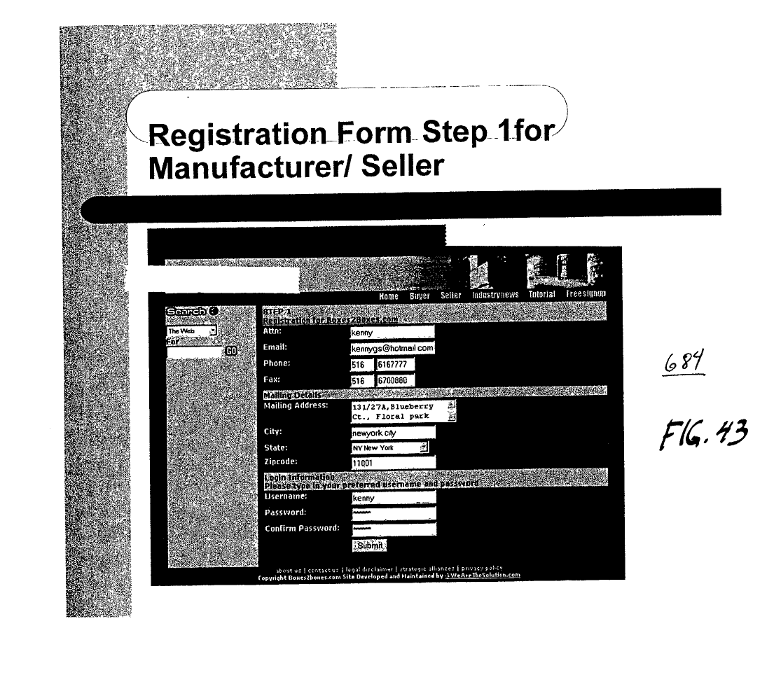

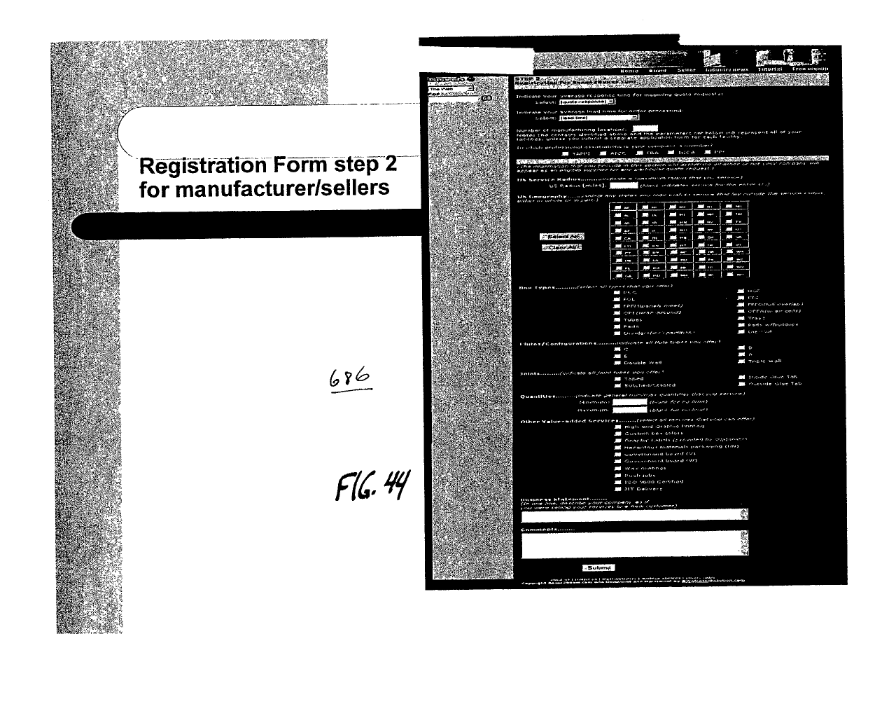

An example of an information page or registration form for a Customer or buyer 12 (20B) is shown at FIG. 42 at 682. The page 682 can include fields for contact information, shipping information and login information. Similarly, an example of information page or registration form for the Manufacturer or Seller 12 (20A) is shown at FIG. 43 at 684. The page 684 can include fields for contact information, mailing details and login information. Further, as shown in FIG. 44 at page 686, detailed information can be solicited. The information can be used to determine various manufacturing capabilities of the Manufacturer 20B. For example, the Manufacturer can be asked to indicate an average response time for income quote requests, an average lead time for order processing and a number of manufacturing locations. The manufacturer may be asked to supply which professional associations the manufacturer belongs. The manufacturer may be asked to supply a service radius, for example, in number of miles. The manufacturer may be asked to supply states that the manufacturer has a capability to service.

Further, the manufacturer media may be asked to supply specific information regarding box-manufacturing capability. For example, the page can include a questionnaire to determine manufacturing capability of box types, configurations, joins, quantities and other value added services.

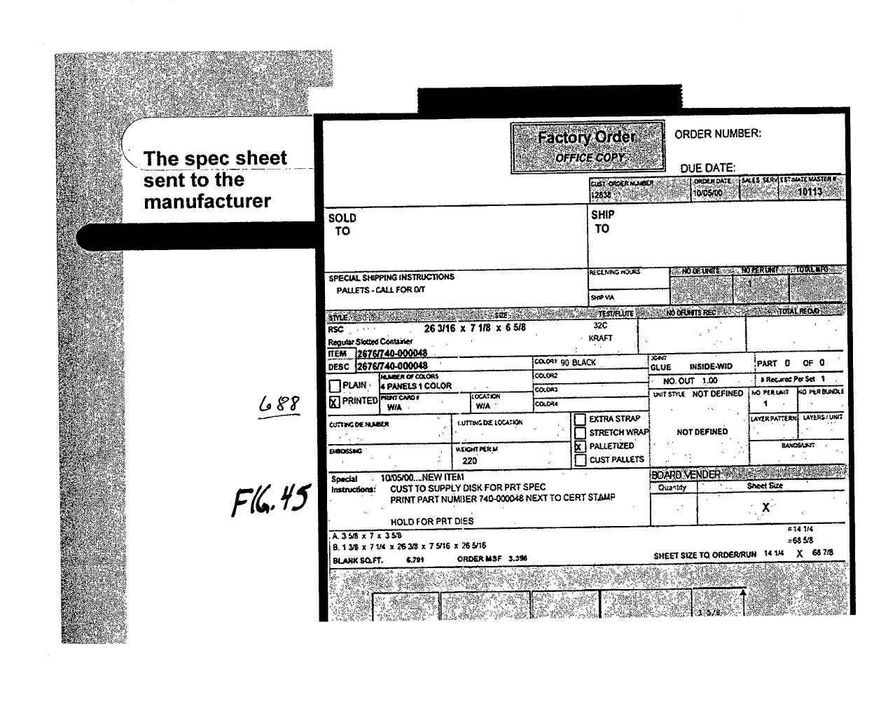

As shown in FIG. 45, page 688 illustrates one embodiment of the spec sheet or factory order form, which can be generated by the Manufacturer Interface 18 as a result of a processed order. It will be understood that the spec sheet can be generated by any suitable method. As is conventional, the spec sheet 688 can include various information, such as an order number, an order date, selling and shipping information, any special shipping instructions and specifications regarding the package to be manufactured.

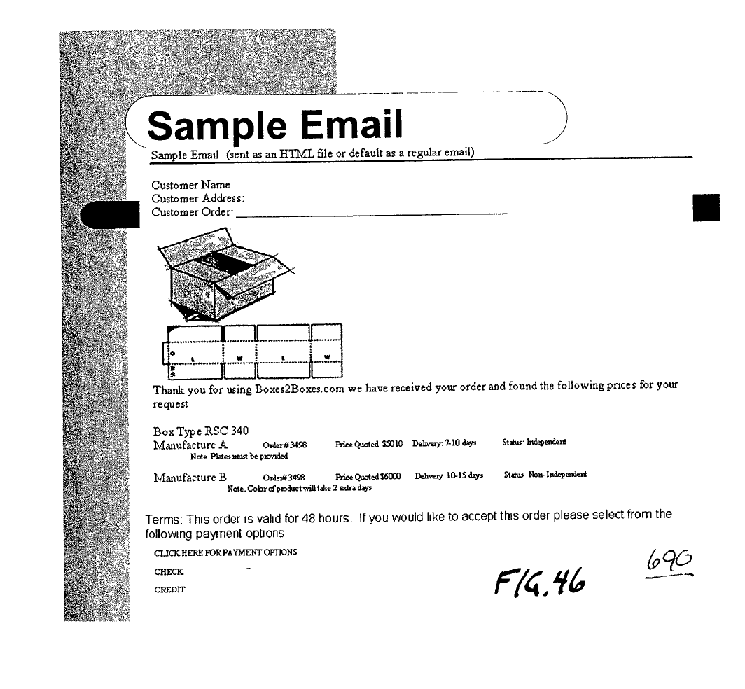

As shown in FIG. 46, page 690 illustrates one embodiment of a notification sent to a customer regarding a specific order. As shown, the notification can be in the form of e-mail. The e-mail can include a depiction of the ordered box in various views. The notification can include information regarding bids placed on the request or order, which can include price quotes, delivery targets, and other manufacturer specific information. Also, the page 690 can include payment options.

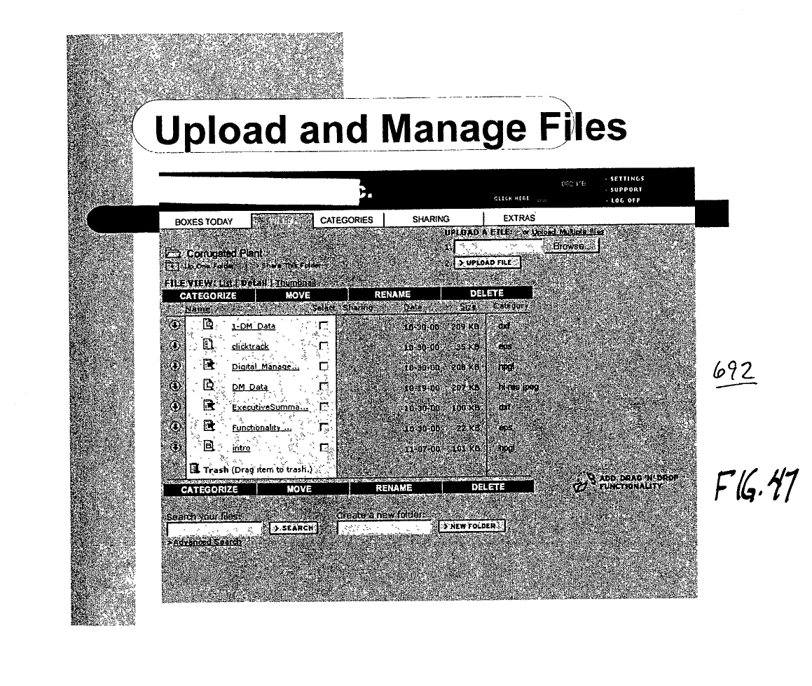

As shown in FIG. 47, page 692 illustrates one embodiment of a utility for uploading and managing electronic files. As shown, the page 692 can include file listing and management features. For example, the page 692 can receive electronic files containing various types of images for reproducing logos, advertisements and other information. In particular, logos can be stored in various formats such as .dxf, .jpg, .hpgl, .eps, gif and so on. Furthermore, logos or artwork can be stored in format for use in an associated CAD program or utility for use in viewing box and logo images and for the production of blueprints and other related industry information with personalization options (see Appendix A) that allow Manufacturers and Customer to submit personal and related data or information. In addition, related manufacturing and customer tools that are industry related, i.e., conversions, sheet conversions along with a pricing matrix (See Appendix D).

In an alternate embodiment, an envelope or other holding device can be formed or attached to a surface of, for example, a box. In one embodiment the holder can be designed to receive an insert providing the third party advertising therein. In one embodiment the holder may be transparent to allow the answer to be viewed without removal. It will be understood that inserts include advertising for products and services. Further, the inserts can include an incentive to provide feedback regarding the user of the package.

Further, the insert may include trackable indicia, such as barcodes, a message, a trackable promotion, a login code, an ID, key, code or other trackable insignia. The trackable code can be associated with a particular advertisements or advertiser to obtain feedback regarding the box owner, the impact of the advertisements, i.e., data mining.

Concerning the overall structure of the system 10, the system 10, in one embodiment, comprises an electronically interactive system that allows for the interaction between a Customer 12, a Manufacturer 20 and an Advertiser 22. In one embodiment, the system 10 may be accessible through the WWW, and may be run on any net server, such as, for example, a Windows™ NT Web Server. Additionally, the system 10 may be accessible by any communication device, such as, for example, a cellular telephone or a personal computer (PC). Additionally, the system 10 uses a connection that can provide such services within a short period of time, such as, for example, OC-3/OC-12 connections, which comprise four 155 MB/sec connectors.

Additionally, the system 10 can comprise a network of technical services that provide the foundation for application and information architecture. For example, the system 10 may include an integration bus or communication service aspect. Included within the integration bus are presentation services, which may be a service such as, for example, Microsoft Internet Explorer™, or Netscape™, and may include, for example, user navigation systems, Web browser systems, performance support systems (i.e., on-line help) and look, feel and navigation standards. Also included within the integration bus are communication services, which may be a service such as, for example, Visibroker™ and MQSeries™, Middleware™, COM™, CORBA™ and RMI™, and may include, for example, messaging services. Also included within the integration bus are environment services, which may be a service such as, for example, Windows NT™, AIX™, Solaris™ and WebSphere™, and may include, for example, an operating system, application integration systems, and Java™ servlets and beans. Also included within the integration bus are integration services, such as, for example, security integration services, application integration services, COM# or CORBA™ bridging and XML services. Also included within the integration bus may be distributed data access services, and document services, such as, for example, SQL Server™, UDB™, Netscape™ LDAP, ODBC, JDBC and XML. Finally, the integrated bus may include distributed security services, Web security services, and system security services, such as, for example, Encryption™, SSL, WebDefender™ and LDAP.

Additionally, the system 10 may include information architecture components, such as, for example, partner/vendor/synchronization components, product search or selection/design components, user registration components, customer order tracking components, user authentication and authorization components and customer profile maintenance components. Examples of such applications for these components may be COM™, LDAP™, various Microsoft™, IBM™ and Netscape™ components, and other components currently known in the art.

The Customer Interface 16, the Manufacturer Interface 18, and the Advertiser Interface 26 are, in one embodiment, configured to receive and process incoming transactions from the users (i.e., the Customer 12, the Manufacturer 20 and the Advertiser 22). The Interfaces can receive and process pages from a paging network and can also receive and process messages (e.g., emails or facsimiles) from a LAN, WAN, wireless data or email system.

The Interfaces may be distributed in various geographic locations throughout the world or the United States (e.g., Chicago, Ill.). The Interfaces may be operated by one or more carriers (e.g., Sprint, Qwest, MCI, etc.) or independent service providers (e.g., Motorola, Inc.). The Interfaces may be integrated with a carrier network or may be located remote from the carrier network. It is also contemplated that one or more of the Interfaces may be integrated into a communication device, such as, for example, a wire-line or wireless telephone, a radio device, a PC, a PDA, a PIM, etc., and can be programmed to connect or link directly to an information source. It is contemplated that the customization software running on the Customer Interface 16 may comprise computer-readable code, and may be both sold and purchased for use on a PC or other communication device.

The Interfaces may also be configured as a standalone system to allow end users to dial directly into the Interfaces via a direct access telephone number. In addition, the Interfaces may comprise a telephony switch (e.g., a PBX or Centrix unit), an enterprise network or a LAN. In this configuration, the system 10 can be implemented to automatically connect a user to an appropriate Interface when the user accesses a communication device.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method of reducing packaging costs with third party advertising comprising:
receiving an order for packaging from a customer; and
applying third party advertising to the packaging.

2. The method of claim 1 further comprising:
reducing packaging costs as a percentage of revenue from the third party advertising.

3. The method of claim 1 further comprising:
receiving at least one customer preference associated with the order.

4. The method of claim 3 wherein the at least one customer preference is selected from the group geographic location, package size, product category, service category, industry category, income category, ethnic category and age category.

5. The method of claim 4 wherein the at least one customer preference includes a request for at least one third party advertisement.

6. The method of claim 5 wherein the at least one customer preference includes a selection of at least one third party advertisement category.

7. The method of claim 2 wherein the order is received via a communication system selected from the group of Internet website, e-mail system, facsimile, telephone system, Postal Service, bulletin board system, website, electronic network, intranet, mobile system and a wireless system.

8. The method of claim 7 wherein the order is received at a communication node.

9. The method of claim 8 wherein third party advertising is applied to the package at a manufacturer.

10. The method of claim 2 further comprising receiving a job quote based on the packaging order.

11. The method of claim 10 further comprising reducing the job quote as a percentage of revenue received from application of the third party advertising to the package.

12. The method of claim 11 further comprising receiving a customer preference only if positive, then proceeding to apply the third party advertising to the package.

13. A method for selecting packaging on which to place an advertisement, comprising:
receiving at least one request to place advertisements on packaging, the request including an advertiser category;
storing the at least one request in an advertiser database;
receiving an order, the order including a customer advertisement preference;
comparing the customer advertisement preference with the advertiser database; and
selecting each of the at least one requests having an advertiser category matching the customer advertisement preference.

14. The method of claim 13 wherein each of the at least one requests further include a product category preference.

15. The method of claim 14 wherein the order further includes a product identification.

16. The method of claim 15 further comprising comparing the product category preference with the product identification.

17. The method of claim 16 further comprising selecting each of the at least one requests having a product category preference matching the product identification.

18. A method for selecting packaging on which to place an advertisement, comprising:
receiving at least one request to place advertisements on packaging, the request including a product category preference;
storing the at least one request in an advertiser database;
receiving an order, the order including a product identification;
comparing the product category reference with the product identification; and
selecting each of the at least one requests having a product category preference matching the product identification.

19. The method of claim 18 wherein each of the at least one requests include an advertiser category.

20. The method of claim 19 wherein the order further includes an advertisement preference.

21. The method of claim 20 further comprising comparing the advertiser category with the advertisement preference.

22. The method of claim 23 further comprising selecting each of the at least one requests having an advertiser category matching the advertisement preference.

23. A method of selecting packaging on which to place an advertisement, comprising:
receiving a customer order for packaging;
receiving at least one advertiser bid for the customer order;
comparing at least one customer preference with advertiser information, the customer preference corresponding to the customer order and the advertiser information corresponding to the advertiser bid; and
selecting the advertiser bid matching the customer preference.

24. A method of placing advertising on a package, comprising:
receiving an order from a customer, the order specifying available space on the package;
receiving at least one bid from at least one advertiser corresponding to the order, the bid specifying the placement of an advertisement on a portion of the space on the package; and
selecting one of the at least one bids for placement on the package.

25. The method of claim 24 further comprising sending a representation of the package with advertisement placed on the portion of the space to a manufacturer.

26. The method of claim 25 further comprising notifying the advertiser corresponding to the selected bid.

27. The method of claim 26 wherein the portion of the space comprises all available space on the package.

28. The method of claim 27 wherein a plurality of bids are selected for placement on the package.
